SEQUENCE LISTING (5 sequences)

SEQ ID NO: 1 - protein, 319 aa, Geobacillus stearothermophilus
VAGTSTVGVGRGVLGDQKYINTTYSSYYGYYYLQDNTRGSGIFTYDGRNRTVLPGSLWADVDNQFFASYDAAAVDAHYYAGVVYDYYKNVHGRLSYDGSNAAIRSTVHYGRGYNNAFWNGSQMVYGDGDGQTFLPFSGGIDVVGHELTHAVTDYTAGLVYQNESGAINEAMSDIFGTLVEFYANRNPDWEIGEDIYTPGIAGDALRSMSDPAKYGDPDHYSKRYTGTQDNGGVHTNSGIINKAAYLLSQGGVHYGVSVTGIGRDKMGKIFYRALVYYLTPTSNFSQLRAACVQAAADLYGSTSQEVNSVKQAFNAVGVY

SEQ ID NO: 2 - protein, 319 aa, Bacillus caldolyticus
VAGTSTVGVGRGVLGDQKYINTTYSSYYGYYYLQDNTRGSGIFTYDGRNRTVLPGSLWADGDNQFFASYDAAAVDAHYYAGVVYDYYKNVHGRLSYDGSNAAIRSTVHYGRGYNNAFWNGSQMVYGDGDGQTFLPFSGGIDVVGHELTHAVTDYTAGLVYQNESGAINEAMSDIFGTLVEFYANRNPDWEIGEDIYTPGIAGDALRSMSDPAKYGDPDHYSKRYTGTQDNGGVHTNSGIINKAAYLLSQGGVHYGVSVTGIGRDKMGKIFYRALVYYLTPTSNFSQLRAACVQAAADLYGSTSQEVNSVKQAFNAVGVY

SEQ ID NO: 3 - protein, 320 aa, Bacillus cereus
VTGTNKVGTGKGVLGDTKSLNTTLSGSSYYLQDNTRGATIFTYDAKNRTTLPGTLWVDADNVFNAAYDAAAVDAHYYAGRTYDYYKATFNRNSINDAGAPLKSTVHYGSKYNNAFWNGSQMVYGDGDGVTFTSLSGGIDVIGHELTHAVTENSSDLIYQNESGALNEAISDIFGTLVEFYDNRNPDWEIGEDIYTPGKAGDALRSMSDPAKYGDPDHYSKRYTGTSDNGGVHTNSGIINKQAYLLANGGTHSGVTVTGIGKDKLGAIYYRANTQYFTQSTTFSQARAGAVQAAADLYGATSAEVAAVKQSFSAVGINHQH

SEQ ID NO: 4 - protein, 320 aa, Bacillus megaterium
VTGTNAIGSGKGVLGDTKSLKTTLSSSTYYLQDNTRGATIYTYDAKNRTSLPGTLWADTDNTYNATRDAAAVDAHYYAGVTYDYYKNKFNRNSYDNAGAPLKSTVHYSSGYNNAFWNGSQMVYGDGDGYTFVPLSGGLDVIGHELTHAVTERSSNLIYQYESGALNEAISDIFGTLVEYYDNRNPDWEIGEDIYTPGTSGDALRSMSNPAKYGDPDHYSKRYTGSSDNGGVHTNSGIINKAAYLLANGGTHYGVTVTGIGGNKLGKIYYRANTLYFTQSTTFSQARAGLIQAAADLYGSGSQEVISVGKSFDAVGVQHQH

SEQ ID NO: 5 - protein, 320 aa, Bacillus cereus
VTGTNKVGTGKGVLGDTKSLNTTLSGSSYYLQDNTRGATIFTYDAKNRSTLPGTLWADADNVFNAAYDAAAVDAHYYAGVTYDYYKNTFNRNSINDAGAPLKSTVHYGSNYNNAFWNGSQMVYGDGDGVTFTSLSGGIDVIGHELTHAVTENSSNLIYQNESGALNEAISDIFGTLVEFYDNRNPDWEIGEDIYTPGKAGDALRSMSDPTKYGDPDHYSKRYTGSSDNGGVHTNSGIINKQAYLLANGGTHYGVTVTGIGKDKLGAIYYRANTQYYTQSTTFSQARAGAVQAAADLYGANSAEVAAVKQSFSAVGINHQH

(19) United States
(12) Patent Application Publication
(10) Pub. No.: US 2014/0038270 A1
(43) Pub. Date: Feb. 6, 2014

(54) Detergent Compositions Comprising Metalloproteases

(71) Applicants: Esben Peter Friis, Herlev (DK); Peter Rahbek Oestergaard, Virum (DK); Astrid Benie, Vaerloese (DK); Preben Nielsen, Hoersholm (DK)

(72) Inventors: Esben Peter Friis, Herlev (DK); Peter Rahbek Oestergaard, Virum (DK); Astrid Benie, Vaerloese (DK); Preben Nielsen, Hoersholm (DK)

(73) Assignee: NOVOZYMES A/S, Bagsvaerd (DK)

(21) Appl. No.: 13/982,435

(22) PCT Filed: Feb. 15, 2012
(86) PCT No.: PCT/EP12/52608

§ 371 Date: Oct. 15, 2013

(30) Foreign Application Priority Data
Feb. 16, 2011 (EP) 11154709.7
Jun. 24, 2011 (EP) 11171336.8

(51) Int. Cl. C11D 3/386

(52) U.S. Cl. CPC C11D 3/38681
USPC 435/263; 510/392; 435/264

(57) ABSTRACT

The present invention relates to the use of Thermolysin-Like Metalloproteases in cleaning processes, such as laundry and dish wash, and in particular to the use in low temperature wash and in removal of egg stains. The invention also relates to detergent compositions and cleaning compositions comprising Thermolysin-Like Metalloproteases.

### REFERENCE TO SEQUENCE LISTING

This application contains a Sequence Listing in computer readable form. The computer readable form is incorporated herein by reference.

### FIELD OF THE INVENTION

The present invention relates to cleaning and/or detergent compositions comprising metalloproteases (E.C 3.4.24). The invention further concerns the use of the metalloproteases in cleaning processes, such as dish wash and laundry. Further the invention concerns methods of doing cleaning, such as dish wash and laundry.

### BACKGROUND OF THE INVENTION

The detergent industry has for more than 30 years implemented different enzymes in detergent formulations, most commonly used enzymes includes proteases, amylases and lipases each adapted for removing various types of stains. In addition to the enzymes detergent compositions typically include a complex combination of ingredients. For example, most cleaning products include surfactant system, bleaching agents or builders. Despite the complexity of current detergents, there remains a need for developing new detergent compositions comprising new enzymes and/or enzyme blends.

Metalloproteases are proteolytic enzymes having an absolute requirement for metal ion for their activity. Most metalloproteases are zinc-dependent, although some use other transition metals. Metalloproteases have been widely used in different industries like food and brewing industry. One of the most well characterized groups of metalloproteases is the thermolysins. The thermolysins belong to the M4 family metalloproteases and have been used, e.g., in peptide synthesis processes. For such applications the thermolysins need to be active at high temperatures and focus has been on increasing their performance at high temperatures. In WO 2004/011619 (Stratagene) thermostabile variants of thermolysin-like protease with altered cleavage specificity is described. For example, the M4 metalloprotease known as Thermolysin has been used as a nonspecific proteinase to obtain fragments for peptide sequencing such as described in, e.g., EP 0 316 725. It has also been used as a peptide synthetase as described in WO 2000/37486, disclosing a method for production of the artificial sweetener aspartame. Another M4 metalloprotease is the Bacillus amyloliquefaciens metalloprotease, also known as Neutrase™, which has been used for many years as an additive in various food and feed products and, e.g., in brewing. This metalloprotease has also been described for use in detergent and cleaning compositions and processes as described, e.g., in WO 2007/044993, use of storage-stable metalloproteases in detergent or WO 2009/058518, and EP 1 288 282 (Unilever), which describes a blend of a metalloprotease and a serine protease for use in dish washing. WO 2000/60042 also describes detergent compositions containing a metalloprotease.

However, the use of metalloproteases in the detergent industry has been very limited and focus has been on the use of the metalloproteases Neutrase™ and/or “NprE” as set forth in WO 2007/044993. Generally, metalloproteases are very unstable under conventional wash conditions and in conventional detergent compositions. Thus, the use of metalloproteases in wash and cleaning processes and in detergents has been limited.

The increased focus on improving the washing processes in order to make them more environmental friendly has resulted in a global tendency to lowering wash time, pH and temperature, decreasing the amount of detergent components which may influence the environment negatively. The present invention is directed to these and other important ends.

### SUMMARY OF THE INVENTION

The present invention relates to the use of Thermolysin-Like Metalloproteases in cleaning processes, such as laundry and dish wash, and in particular to the use in low temperature wash and in removal of egg stains. The invention also relates to detergent compositions and cleaning compositions comprising Thermolysin-Like Metalloproteases.

In a particular embodiment, the invention relates to the use of a Thermolysin-Like Metalloprotease in a cleaning process.

In a particular embodiment, the invention relates to a method of cleaning, said method comprising the steps of: contacting an surface in need of cleaning with a Thermolysin-Like Metalloprotease.

In a particular embodiment, the invention relates to a composition comprising a Thermolysin-Like Metalloprotease and a surfactant.

In a particular embodiment, the invention relates to a method for removing a stain from a surface which comprises contacting the surface with a composition according to the invention.

### BRIEF DESCRIPTION OF THE DRAWINGS

FIG. 1 shows an alignment of M4 domains.

### DETAILED DESCRIPTION OF THE INVENTION

### Definitions

The term “protease activity” or “peptidase activity” is defined herein as the ability to break down the amide bond of a protein by hydrolysis of the peptide bonds that link amino acids together in a polypeptide chain.

The term “metalloprotease” as used herein refers to a protease having one or more metal ions in the binding/active site.

The term “M4 Metalloprotease Family” or “M4 Metalloprotease” or “M4” as used herein means a polypeptide falling into the M4 metalloprotease family according to Rawlings et al., Biochem. J., 290, 205-218 (1993) and as further described in MEROPS—(Rawlings et al., MEROPS: the peptidase database, Nucl Acids Res, 34 Database issue, D270-272, 2006). The M4 metalloproteases are neutral metalloproteases containing mainly endopeptidases. All peptidases in the family bind a single, catalytic zinc ion. M4 metalloprotease family members include the common HEXXH motif, where the histidine residues serve as zinc ligands and glutamate is an active site residue. M4 metalloproteases have a pH optimum mainly at neutral pH. The M4 metalloprotease family includes, e.g., Neutrase™ (classified as MEROPS subclass M04.014), Thermolysin, Bacillolysin, vibriolysin, pseudolysin, Msp peptidase, coccolysin, aureolysin, vimelysin, lambda toxin neutral peptidase B, PA peptidase (Aeromonas-type), griselysin, stearolysin, MprIII (Alteromonas sp. strain 0-7), pap6 peptidase, neutral peptidase (Thermoactinomyces-type), ZmpA peptidase (Burkholderia sp.), zpx peptidase, PrtS peptidase (Photorhabdus luminescens), protealysin, ZmpB peptidase (Burkholderia sp.). The M4 metalloprotease family of polypeptides have been further characterized and presently includes, according to MEROPS, at least twenty-two subclasses for which a distinct MEROPS ID (i.e., an identifier of the formula M04.xxx) has been assigned, as well as non-peptidase homologues and unassigned peptidases.

The term “isolated polypeptide” as used herein refers to a polypeptide that is isolated from a source. In one aspect, the variant or polypeptide is at least 20% pure, more preferably at least 40% pure, more preferably at least 60% pure, even more preferably at least 80% pure, most preferably at least 90% pure and even most preferably at least 95% pure, as determined by SDS-PAGE.

The term “substantially pure polypeptide” denotes herein a polypeptide preparation that contains at most 10%, preferably at most 8%, more preferably at most 6%, more preferably at most 5%, more preferably at most 4%, more preferably at most 3%, even more preferably at most 2%, most preferably at most 1%, and even most preferably at most 0.5% by weight of other polypeptide material with which it is natively or recombinantly associated. It is, therefore, preferred that the substantially pure polypeptide is at least 92% pure, preferably at least 94% pure, more preferably at least 95% pure, more preferably at least 96% pure, more preferably at least 97% pure, more preferably at least 98% pure, even more preferably at least 99%, most preferably at least 99.5% pure, and even most preferably 100% pure by weight of the total polypeptide material present in the preparation. The polypeptides of the present invention are preferably in a substantially pure form. This can be accomplished, for example, by preparing the variant or polypeptide by well-known recombinant methods or by classical purification methods.

The term “mature polypeptide coding sequence” means a polynucleotide that encodes a mature polypeptide having protease activity.

The relatedness between two amino acid sequences or between two nucleotide sequences is described by the parameter “sequence identity”. For purposes of the present invention, the degree of identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends in Genetics 16: 276-277; http://emboss.org), preferably version 3.0.0 or later. The optional parameters used are gap open penalty of 10, gap extension penalty of 0.5, and the EBLOSUM62 (EMBOSS version of BLOSUM62) substitution matrix. The output of Needle labeled “longest identity” (obtained using the—nobrief option) is used as the percent identity and is calculated as follows:

(Identical Residues×100)/(Length of Alignment−Total Number of Gaps in Alignment)

For purposes of the present invention, the degree of identity between two deoxyribonucleotide sequences is determined using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra; http://emboss.org), preferably version 3.0.0 or later. The optional parameters used are gap open penalty of 10, gap extension penalty of 0.5, and the EDNAFULL (EMBOSS version of NCBI NUC4.4) substitution matrix. The output of Needle labeled “longest identity” (obtained using the—nobrief option) is used as the percent identity and is calculated as follows:

(Identical Deoxyribonucleotides×100)/(Length of Alignment−Total Number of Gaps in Alignment)

The term “fragment” means a polypeptide having one or more (several) amino acids deleted from the amino and/or carboxyl terminus of a mature polypeptide; wherein the fragment has protease activity.

The term “functional fragment of a polypeptide” or “functional fragment thereof” is used to describe a polypeptide which is derived from a longer polypeptide, e.g., a mature polypeptide, and which has been truncated either in the N-terminal region or the C-terminal region or in both regions to generate a fragment of the parent polypeptide. To be a functional polypeptide the fragment must maintain at least 20%, preferably at least 40%, more preferably at least 50%, more preferably at least 60%, more preferably at least 70%, more preferably at least 80%, even more preferably at least 90%, most preferably at least 95%, and even most preferably at least 100% of the protease activity of the full-length/mature polypeptide. An M4 Metalloprotease such as a Thermolysin-Like Metalloprotease may be truncated such that certain domain is removed to generate a functional fragment, which may be polypeptides where less than 200 amino acids have been removed from the mature M4 Metalloprotease, preferably less than 150 amino acids, more preferably less than 120, 100, 80, 60, 40, 30 amino acids, even more preferably less than 20 amino acids and most preferably less than 10 amino acids have been removed from the mature polypeptide.

The term “subsequence” means a polynucleotide having one or more (several) nucleotides deleted from the 5′ and/or 3′ end of a mature polypeptide coding sequence; wherein the subsequence encodes a fragment having protease activity.

The term “allelic variant” means any of two or more alternative forms of a gene occupying the same chromosomal locus. Allelic variation arises naturally through mutation, and may result in polymorphism within populations. Gene mutations can be silent (no change in the encoded polypeptide) or may encode polypeptides having altered amino acid sequences. An allelic variant of a polypeptide is a polypeptide encoded by an allelic variant of a gene.

The term “variant” means a polypeptide having metalloprotease activity comprising an alteration, i.e., a substitution, insertion, and/or deletion of one or more (several) amino acid residues at one or more (several) positions. A substitution means a replacement of an amino acid occupying a position with a different amino acid; a deletion means removal of an amino acid occupying a position; and an insertion means adding 1-3 amino acids adjacent to an amino acid occupying a position.

The terms “cleaning compositions” and “cleaning formulations,” refer to compositions that find use in the removal of undesired compounds from items to be cleaned, such as fabric, carpets, dishware including glassware, contact lenses, hard surfaces such as tiles, zincs, floors, and table surfaces, hair (shampoos), skin (soaps and creams), teeth (mouthwashes, toothpastes), etc. The terms encompasses any materials/compounds selected for the particular type of cleaning composition desired and the form of the product (e.g., liquid, gel, granule, or spray compositions), as long as the composition is compatible with the metalloprotease and other enzyme(s) used in the composition. The specific selection of cleaning composition materials is readily made by considering the surface, item or fabric to be cleaned, and the desired form of the composition for the cleaning conditions during use. These terms further refer to any composition that is suited for cleaning, bleaching, disinfecting, and/or sterilizing any object and/or surface. It is intended that the terms include, but are not limited to detergent composition (e.g., liquid and/or solid laundry detergents and fine fabric detergents; hard surface cleaning formulations, such as for glass, wood, ceramic and metal counter tops and windows; carpet cleaners; oven cleaners; fabric fresheners; fabric softeners; and textile and laundry pre-spotters, as well as dish detergents).

The term “detergent composition”, includes unless otherwise indicated, granular or powder-form all-purpose or heavy-duty washing agents, especially cleaning detergents; liquid, gel or paste-form all-purpose washing agents, especially the so-called heavy-duty liquid (HDL) types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, mouthwashes, denture cleaners, car or carpet shampoos, bathroom cleaners; hair shampoos and hair-rinses; shower gels, foam baths; metal cleaners; as well as cleaning auxiliaries such as bleach additives and “stain-stick” or pre-treat types.

The terms “detergent composition” and “detergent formulation” are used in reference to mixtures which are intended for use in a wash medium for the cleaning of soiled objects. In some embodiments, the term is used in reference to laundering fabrics and/or garments (e.g., “laundry detergents”). In alternative embodiments, the term refers to other detergents, such as those used to clean dishes, cutlery, etc. (e.g., “dishwashing detergents”). It is not intended that the present invention be limited to any particular detergent formulation or composition. It is intended that in addition to the Thermolysin-Like Metalloprotease according to the invention, the term encompasses detergents that contains, e.g., surfactants, builders, chelators or chelating agents, bleach system or bleach components, polymers, fabric conditioners, foam boosters, suds suppressors, dyes, perfume, tannish inhibitors, optical brighteners, bactericides, fungicides, soil suspending agents, anti corrosion agents, enzyme inhibitors or stabilizers, enzyme activators, transferase(s), hydrolytic enzymes, oxido reductases, bluing agents and fluorescent dyes, antioxidants, and solubilizers.

The term “fabric” encompasses any textile material. Thus, it is intended that the term encompass garments, as well as fabrics, yarns, fibers, non-woven materials, natural materials, synthetic materials, and any other textile material.

The term “textile” refers to woven fabrics, as well as staple fibers and filaments suitable for conversion to or use as yarns, woven, knit, and non-woven fabrics. The term encompasses yarns made from natural, as well as synthetic (e.g., manufactured) fibers. The term, “textile materials” is a general term for fibers, yarn intermediates, yarn, fabrics, and products made from fabrics (e.g., garments and other articles).

The term “non-fabric detergent compositions” include non-textile surface detergent compositions, including but not limited to dishwashing detergent compositions, oral detergent compositions, denture detergent compositions, and personal cleansing compositions.

The term “effective amount of enzyme” refers to the quantity of enzyme necessary to achieve the enzymatic activity required in the specific application, e.g., in a defined detergent composition. Such effective amounts are readily ascertained by one of ordinary skill in the art and are based on many factors, such as the particular enzyme used, the cleaning application, the specific composition of the detergent composition, and whether a liquid or dry (e.g., granular, bar) composition is required, and the like. The term “effective amount” of a metalloprotease refers to the quantity of metalloprotease described hereinbefore that achieves a desired level of enzymatic activity, e.g., in a defined detergent composition.

The term “wash performance” of an enzyme refers to the contribution of an enzyme to washing that provides additional cleaning performance to the detergent without the addition of the enzyme to the composition. Wash performance is compared under relevant washing conditions. Wash performance of enzymes is conveniently measured by their ability to remove certain representative stains under appropriate test conditions. In these test systems, other relevant factors, such as detergent composition, detergent concentration, water hardness, washing mechanics, time, pH, and/or temperature, can be controlled in such a way that conditions typical for household application in a certain market segment are imitated.

The term “water hardness” or “degree of hardness” or “dH” or “° dH” as used herein refers to German degrees of hardness. One degree is defined as 10 milligrams of calcium oxide per litre of water.

The term “relevant washing conditions” is used herein to indicate the conditions, particularly washing temperature, time, washing mechanics, detergent concentration, type of detergent and water hardness, actually used in households in a detergent market segment.

The term “improved property” is used to indicate that a better end result is obtained in a property compared to the same process performed without the enzyme. Exemplary properties which are preferably improved in the processes of the present invention include wash performance, enzyme stability, enzyme activity and substrate specificity.

The term “improved wash performance” is used to indicate that a better end result is obtained in stain removal from items washed (e.g., fabrics or dishware and/or cutlery) under relevant washing conditions as compared to no enzyme or to a reference enzyme, or that less enzyme, on weight basis, is needed to obtain the same end result relative to no enzyme or to a reference enzyme. Improved wash performance could in this context also be that the same effect, e.g., stain removal effect is obtained in shorter wash time, e.g., the enzymes provide their effect more quickly under the tested conditions.

The term “retained wash performance” is used to indicate that the wash performance of an enzyme, on weight basis, is at least 80 percent relative to another enzyme under relevant washing conditions.

The term “enzyme detergency” or “detergency” or “detergency effect” is defined herein as the advantageous effect an enzyme may add to a detergent compared to the same detergent without the enzyme. Important detergency benefits which can be provided by enzymes are stain removal with no or very little visible soils after washing and/or cleaning, prevention or reduction of redeposition of soils released in the washing process an effect that also is termed anti-redeposition, restoring fully or partly the whiteness of textiles, which originally were white but after repeated use and wash have obtained a greyish or yellowish appearance an effect that also is termed whitening. Textile care benefits, which are not directly related to catalytic stain removal or prevention of redeposition of soils, are also important for enzyme detergency benefits. Examples of such textile care benefits are prevention or reduction of dye transfer from one fabric to another fabric or another part of the same fabric an effect that is also termed dye transfer inhibition or anti-back staining, removal of protruding or broken fibers from a fabric surface to decrease pilling tendencies or remove already existing pills or fuzz an effect that also is termed anti-pilling, improvement of the fabric-softness, colour clarification of the fabric and removal of particulate soils which are trapped in the fibers of the fabric or garment. Enzymatic bleaching is a further enzyme detergency benefit where the catalytic activity generally is used to catalyze the formation of bleaching component such as hydrogen peroxide or other peroxides.

The term “anti-redeposition” as used herein describes the reduction or prevention of redeposition of soils dissolved or suspended in the wash liquor onto the cleaned objects. Redeposition may be seen after one or multiple washing cycles (e.g., as a greying, yellowing or other discolorations).

The term “adjunct materials” means any liquid, solid or gaseous material selected for the particular type of detergent composition desired and the form of the product (e.g., liquid, granule, powder, bar, paste, spray, tablet, gel, or foam composition), which materials are also preferably compatible with the metalloprotease enzyme used in the composition. In some embodiments, granular compositions are in “compact” form, while in other embodiments, the liquid compositions are in a “concentrated” form.

The term “stain removing enzyme” as used herein, describes an enzyme that aids the removal of a stain or soil from a fabric or a hard surface. Stain removing enzymes act on specific substrates, e.g., protease on protein, amylase on starch, lipase and cutinase on lipids (fats and oils), pectinase on pectin and hemicellulases on hemicellulose. Stains are often depositions of complex mixtures of different components which either results in a local discolouration of the material by itself or which leaves a sticky surface on the object which may attract soils dissolved in the washing liquor thereby resulting in discolouration of the stained area. When an enzyme acts on its specific substrate present in a stain the enzyme degrades or partially degrades its substrate thereby aiding the removal of soils and stain components associated with the substrate during the washing process. For example, when a protease acts on a grass stain it degrades the protein components in the grass and allows the green/brown colour to be released during washing.

The term “reduced amount” means in this context that the amount of the component is smaller than the amount which would be used in a reference process under otherwise the same conditions. In a preferred embodiment the amount is reduced by, e.g., at least 5%, such as at least 10%, at least 15%, at least 20% or as otherwise herein described.

The term “low detergent concentration” system includes detergents where less than about 800 ppm of detergent components are present in the wash water. Asian, e.g., Japanese detergents are typically considered low detergent concentration systems.

The term “medium detergent concentration” system includes detergents wherein between about 800 ppm and about 2000 ppm of detergent components are present in the wash water. North American detergents are generally considered to be medium detergent concentration systems.

The term “high detergent concentration” system includes detergents wherein greater than about 2000 ppm of detergent components are present in the wash water. European detergents are generally considered to be high detergent concentration systems.

### Thermolysin-Like Metalloprotease (TLP)

The present invention relates to the use of isolated polypeptides of the M4 Metalloprotease Family in general. Thus in one embodiment, the invention relates to the use of isolated polypeptides which are a subclass of the M4 Metallprotease Family, and which are referred to herein as a “Thermolysin-Like Metalloprotease” or “TLP”.

In particular, the present inventors have reviewed the approximately 500 publicly available sequences classified in the M4 Metalloprotease Family and have identified subset thereof which are the Thermolysin-like Metalloproteases and which are surprisingly useful in cleaning compositions and processes, such as dish wash and laundry. One of skill in the art will recognize that the MEROPS classification system, and in particular the assignment of subclasses according to MEROPS, is based primarily on sequence identity but also includes other factors such as enzyme activity and other properties based on the relevant literature.

The Thermolysin-Like Metalloproteases are described, e.g., in Barret et al. (1998) Handbook of proteolytic enzymes. Academic Press, pp. 350-369. The amino acid sequences of several TLPs have been determined, and the three dimensional structures of several TLPs have been solved. Focus has been on increasing the thermostability of the TLP and a number of publications describe the thermostability of Bacillus TLPs, e.g., Veltman et al., (1998) Biochemistry 37(15):5312-9. The TLPs consist of an alpha-helical C-terminal domain and an N-terminal domain mainly consisting of beta-strands. The domains are connected by a central alpha-helix. This helix is located at the bottom of the active site cleft and contains several of the catalytically important residues such as four substrate binding pockets S₂, S₁, S₁′ and S₂′ have been identified (Hangauer et al. (1984) Biochemistry 23:5730-5741).

The Thermolysin-Like Metalloproteases are known as being thermostable and for this reason it is surprising that the Thermolysin-Like Metalloproteases are active in the detergent cleaning compositions and processes according to the invention, such as low temperature wash and egg removal.

In a particular embodiment, Thermolysin-Like Metalloprotease useful according to the present invention include:
(a) an M4 metalloprotease of the MEROPS subclass M04.001;
(b) an M4 metalloprotease of the MEROPS subclass M04.018;
(c) an M4 metallprotease of the MEROPS subclass M04.021;
(d) an M4 metalloprotease having an active cleft motif: TG[TS][QS]DNGGVH[TI];
(e) an M4 metalloprotease having an active cleft motif: DPDHYSKRYTG[TS][QS]NGGVH[TI]NSGI;
(f) an M4 metalloprotease having an active cleft motif: NT[TS][QS]DNGGVH[TI]NSGI.

In the above motifs, the accepted IUPAC single letter amino acid abbreviation is employed. Also in the above motifs, the use of brackets indicates alternative amino acid choices at a particular position. The invention has been demonstrated using the exemplary isolated Thermolysin-Like Metalloproteases set forth below. Some of these Thermolysin-Like Metalloproteases are publicly available, either as fully expressed proteins or in sequence databases as open reading frames resulting from genome sequencing projects (indicated with reference in Table 1).

Table 1 is a list of the Thermolysin-Like Metalloproteases which have been used to illustrate the present invention and which can be applied in all the uses of the present invention.

TABLE 1

| SEQ | MEROPS | | Short | |
|---|---|---|---|---|
| ID NO | subclass | Organism | name | Reference |
| 1 | M4.018 | G. stearothermophilus | Gs1 | Uniprot: Q59223 |
| 2 | M4.018 | B. caldolyticus | Bca1 | WO 2004/011619 |
| | | | | Uniprot: Q59193 |
| 3 | M4.001 | B. cereus | Bce1 | Uniprot: Q73DP5 |
| | | | | expressed with a |
| | | | | -HQHQHQH tag |
| 4 | M4.001 | B. megaterium | Bm1 | Uniprot: Q00891 |
| | | | | expressed with a |
| | | | | -HQHQHQH tag |
| 5 | M4.001 | B. cereus | Bce2 | Uniprot: C2Y5X9 |
| | | | | expressed with a |
| | | | | -HQHQHQH tag |

One of skill in the art will recognize that the mature protein may in some embodiments be part of a longer sequence that includes, e.g., an appropriate propeptide and/or signal peptide sequence.

The sequence identity between the exemplary Thermolysin-Like Metalloproteases of Table 1 is given below. The identities corresponds to the number of exact matches divided by the total length of the alignment excluding the gaps and are calculated as indicated in the definitions.

| | | Gs1 | Bca1 | Bce1 | Bm1 | Bce2 |
|---|---|---|---|---|---|---|
| SEQ ID NO: 1 | Gs1 | 100.00 | 99.69 | 73.19 | 72.56 | 73.19 |
| SEQ ID NO: 2 | Bca1 | 99.69 | 100.00 | 73.19 | 72.56 | 73.19 |
| SEQ ID NO: 3 | Bce1 | 73.19 | 73.19 | 100.00 | 83.75 | 96.56 |
| SEQ ID NO: 4 | Bm1 | 72.56 | 72.56 | 83.75 | 100.00 | 84.69 |
| SEQ ID NO: 5 | Bce2 | 73.19 | 73.19 | 96.56 | 84.69 | 100.00 |

In a preferred embodiment of the invention, the following subset of Thermolysin-Like Metalloproteases indicated in Table 2 can be applied in all uses of the present invention.

TABLE 2

| SEQ | MEROPS | | Short | |
|---|---|---|---|---|
| ID NO | subclass | Organism | name | Reference |
| 1 | M4.018 | G. stearothermophilus | Gs1 | Uniprot: Q59223 |
| 2 | M4.018 | B. caldolyticus | Bca1 | WO 2004/011619 |
| 4 | M4.001 | B. megaterium | Bm1 | Uniprot: Q00891 |
| | | | | expressed with a |
| | | | | -HQHQHQH tag |

As previously stated, the active cleft motifs identified by the present inventors provide further amino acid sequence information that distinguishes the Thermolysin-Like Metalloproteases of the present invention from other metalloproteases, including other M4 Metalloproteases.

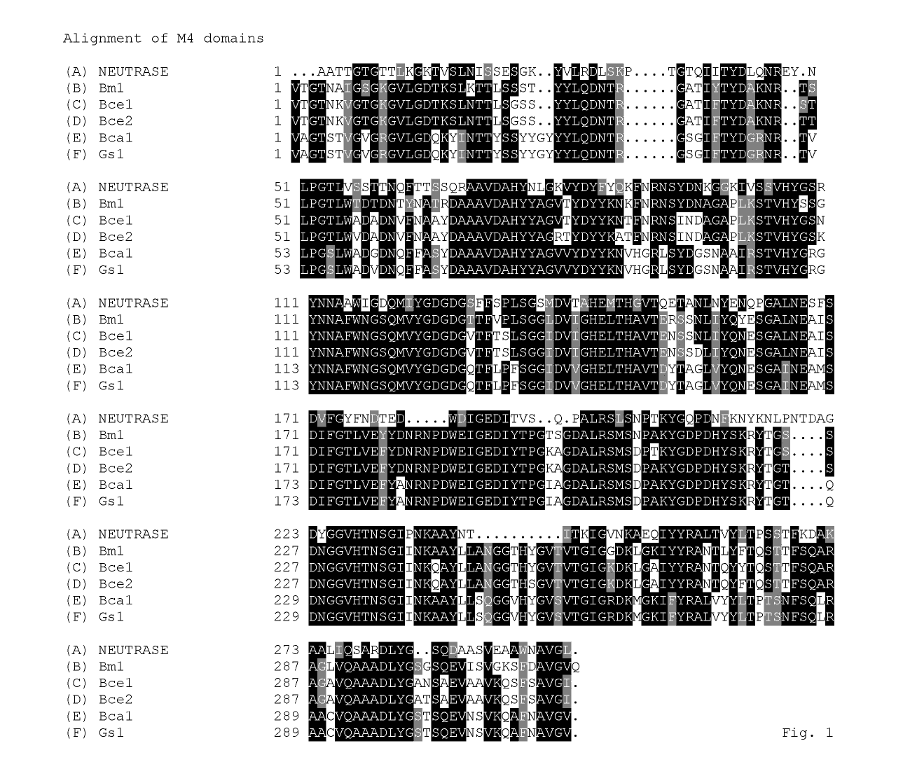

FIG. 1 provides alignment of the M4 domains of exemplary Thermolysin-Like Metalloproteases according to the present invention (rows (B)-(F) of FIG. 1) as compared to the M4 domain of the M4 Metalloprotease Neutrase™ (row (A) of FIG. 1). From the alignment information, the present inventors have deduced the active cleft motifs that distinguish the Thermolysin-Like Metalloproteases of the present invention. The active cleft motif TG[TS][QS]DNGGVH[TI] can be seen at, e.g., positions 223-237 of Bm1, Bce1 and Bce2 and at positions 225-239 of Gs1 and Bca1. The active cleft motif DPDHYSKRYTG[TS][QS]DNGGVH[TI]NSGI can be seen at, e.g., positions 114-237 of Bm1, Bce1 and Bce2 and at positions 116-239 of Gs1 and Bca1. In contrast, Neutrase™ does not have these active cleft motifs.

In a particular embodiment, exemplary Thermolysin-Like Metalloproteases useful according to the present invention include peptidases having the following MEROPS database accession numbers:

| | | | | | |
|---|---|---|---|---|---|
| MER001027 | MER001026 | MER001353 | MER001927 | MER001034 | MER168133 |
| MER040474 | MER001025 | MER109364 | MER187794 | MER187790 | MER187808 |
| MER061817 | MER176709 | MER003181 | MER001030 | MER187798 | MER109389 |
| MER021824 | MER001354 | MER001031 | MER109427 | MER169677 | MER001028 |
| MER124526 | MER091675 | MER168882 | MER187765 | MER001033 | MER187793 |
| MER187797 | MER187787 | | | | |

In a preferred embodiment, the Thermolysin-Like Metalloproteases applied in the uses of the present invention is a mature polypeptide or a functional fragment thereof. More preferably at least one of the mature Thermolysin-Like Metalloproteases in Table 1-2 or a functional fragment thereof is applied in the uses of the present invention. Even more preferably a polypeptide comprising at least one of the MEROPS subclasses and/or active cleft motifs (a)-(d) outlined above or a functional fragment thereof is applied in the uses of the present invention.

In addition to the uses of the Thermolysin-Like Metalloproteases in Table 1, the present invention encompasses the use of polypeptides having at least 70%, such as at least 75%, such as at least 80%, such as at least 85%, such as at least 86%, such as at least 87%, such as at least 88%, such as at least 89%, such as at least 90%, such as at least 91%, such as at least 92%, such as at least 93%, such as at least 94%, such as at least 95%, such as at least 96%, such as at least 97%, such as at least 98%, such as at least 99% or even 100% sequence identity to the mature polypeptide of any one of SEQ ID NO:s 1, 2, 3, 4 or 5 or a functional fragment thereof, which can still be classified as a Thermolysin-Like Metalloproteases (hereinafter “homologous polypeptides”). In a preferred aspect, the homologous polypeptides have an amino acid sequence which differs by ten amino acids, preferably by five amino acids, more preferably by four amino acids, even more preferably by three amino acids, most preferably by two amino acids, and even most preferably by one amino acid to any one of SEQ ID NO:s 1, 2, 3, 4 or 5. A polypeptide of the present invention preferably comprises or consists of the amino acid sequence of SEQ ID NO: 1, 2, 3, 4 or 5, or an allelic variant thereof; or a functional fragment thereof. In another aspect, the polypeptide comprises or consists of the mature polypeptide of SEQ ID NO: 1, 2, 3, 4 or 5.

Substantially homologous polypeptides of the sequences described above are characterized as having one or more (several) amino acid substitutions, deletions, and/or insertions in the mature polypeptide. Preferably, amino acid changes are of a minor nature, that is conservative amino acid substitutions or insertions that do not significantly affect the folding and/or activity of the protein; small deletions, typically of one to about nine amino acids, such as one, two, three, four, five, six, seven, eight or nine amino acids; preferably from one to about 15 amino acids, such as 10, 11, 12, 13, 14 or 15 amino acids; and most preferably from one to about 30 amino acids, such as 16, 17, 18, 19, 20, 21, 22, 23, 24, 25, 26, 27, 28, 29 or 30 amino acids; small amino- or carboxyl-terminal extensions, such as an amino-terminal methionine residue; a small linker peptide of up to about five to ten residues, preferably from 10 to 15 residues and most preferably from 20 to 25 residues, or a small extension that facilitates purification by changing net charge or another function, such as a poly-histidine tag, an antigenic epitope, protein A, a carbohydrate binding module or a another binding domain.

Examples of conservative substitutions are within the group of basic amino acids (arginine, lysine and histidine), acidic amino acids (glutamic acid and aspartic acid), polar amino acids (glutamine and asparagine), hydrophobic amino acids (leucine, isoleucine and valine), aromatic amino acids (phenylalanine, tryptophan and tyrosine), and small amino acids (glycine, alanine, serine, threonine and methionine). Amino acid substitutions that do not generally alter specific activity are known in the art and are described, for example, by H. Neurath and R. L. Hill, 1979, In, The Proteins, Academic Press, New York. The most commonly occurring exchanges are Ala/Ser, Val/Ile, Asp/Glu, Thr/Ser, Ala/Gly, Ala/Thr, Ser/Asn, Ala/Val, Ser/Gly, Tyr/Phe, Ala/Pro, Lys/Arg, Asp/Asn, Leu/Ile, Leu/Val, Ala/Glu, and Asp/Gly.

In addition to the 20 standard amino acids, non-standard amino acids (such as 4-hydroxyproline, 6-N-methyl lysine, 2-aminoisobutyric acid, isovaline, and alpha-methyl serine) may be substituted for amino acid residues of a wild-type polypeptide. A limited number of non-conservative amino acids, amino acids that are not encoded by the genetic code, and unnatural amino acids may be substituted for amino acid residues. “Unnatural amino acids” have been modified after protein synthesis, and/or have a chemical structure in their side chain(s) different from that of the standard amino acids. Unnatural amino acids can be chemically synthesized, and preferably, are commercially available, and include pipecolic acid, thiazolidine carboxylic acid, dehydroproline, 3- and 4-methylproline, and 3,3-dimethylproline.

Alternatively, the amino acid changes are of such a nature that the physico-chemical properties of the polypeptides are altered. For example, amino acid changes may improve the thermal stability of the polypeptide, alter the substrate specificity, change the pH optimum, and the like.

Essential amino acids in the parent polypeptide can be identified according to procedures known in the art, such as site-directed mutagenesis or alanine-scanning mutagenesis (Cunningham and Wells, 1989, Science 244: 1081-1085). In the latter technique, single alanine mutations are introduced at every residue in the molecule, and the resultant mutant molecules are tested for biological activity (i.e., detergency) to identify amino acid residues that are critical to the activity of the molecule. See also, Hilton et al., 1996, J. Biol. Chem. 271: 4699-4708. Three dimensional structures, such as alpha-helixes, beta-sheets, as well as metal binding site of the enzyme or other biological interaction can also be determined by physical analysis of structure, as determined by such techniques as nuclear magnetic resonance, crystallography, electron diffraction, or photoaffinity labeling, in conjunction with mutation of putative contact site amino acids. See, for example, de Vos et al., 1992, Science 255: 306-312; Smith et al., 1992, J. Mol. Biol. 224: 899-904; Wlodaver et al., 1992, FEBS Lett. 309: 59-64. The identities of essential amino acids can also be inferred from analysis of identities with polypeptides that are related to a polypeptide according to the invention.

Single or multiple amino acid substitutions, deletions, and/or insertions can be made and tested using known methods of mutagenesis, recombination, and/or shuffling, followed by a relevant screening procedure, such as those disclosed by Reidhaar-Olson and Sauer, 1988, Science 241: 53-57; Bowie and Sauer, 1989, Proc. Natl. Acad. Sci. USA 86: 2152-2156; WO 95/17413; or WO 95/22625. Other methods that can be used include error-prone PCR, phage display (e.g., Lowman et al., 1991, Biochem. 30: 10832-10837; U.S. Pat. No. 5,223,409; WO 92/06204), and region-directed mutagenesis (Derbyshire et al., 1986, Gene 46: 145; Ner et al., 1988, DNA 7: 127).

Mutagenesis/shuffling methods can be combined with high-throughput, automated screening methods to detect activity of cloned, mutagenized polypeptides expressed by host cells (Ness et al., 1999, Nature Biotechnology 17: 893-896). Mutagenized DNA molecules that encode active polypeptides can be recovered from the host cells and rapidly sequenced using standard methods in the art. These methods allow the rapid determination of the importance of individual amino acid residues in a polypeptide of interest, and can be applied to polypeptides of unknown structure.

The polypeptide may be hybrid polypeptide in which a portion of one polypeptide is fused at the N-terminus or the C-terminus of a portion of another polypeptide.

The polypeptide may be a fused polypeptide or cleavable fusion polypeptide in which another polypeptide is fused at the N-terminus or the C-terminus of the polypeptide of the present invention. A fused polypeptide is produced by fusing a polynucleotide encoding another polypeptide to a polynucleotide of the present invention. Techniques for producing fusion polypeptides are known in the art, and include ligating the coding sequences encoding the polypeptides so that they are in frame and that expression of the fused polypeptide is under control of the same promoter(s) and terminator. Fusion proteins may also be constructed using intein technology in which fusions are created post-translationally (Cooper et al., 1993, EMBO J. 12: 2575-2583; Dawson et al., 1994, Science 266: 776-779).

A fusion polypeptide can further comprise a cleavage site between the two polypeptides. Upon secretion of the fusion protein, the site is cleaved releasing the two polypeptides. Examples of cleavage sites include, but are not limited to, the sites disclosed in Martin et al., 2003, J. Ind. Microbiol. Biotechnol. 3: 568-576; Svetina et al., 2000, J. Biotechnol. 76: 245-251; Rasmussen-Wilson et al., 1997, Appl. Environ. Microbiol. 63: 3488-3493; Ward et al., 1995, Biotechnology 13: 498-503; and Contreras et al., 1991, Biotechnology 9: 378-381; Eaton et al., 1986, Biochemistry 25: 505-512; Collins-Racie et al., 1995, Biotechnology 13: 982-987; Carter et al., 1989, Proteins: Structure, Function, and Genetics 6: 240-248; and Stevens, 2003, Drug Discovery World 4: 35-48.

Sources of Thermolysin-Like Metalloproteases

A Thermolysin-Like Metalloprotease useful in the present invention may be obtained from microorganisms of any genus. For purposes of the present invention, the term “obtained from” as used herein in connection with a given source shall mean that the polypeptide encoded by a nucleotide sequence is produced by the source in which it is naturally present or by a strain in which the nucleotide sequence from the source has been inserted. In a preferred aspect, the polypeptide obtained from a given source is secreted extracellularly.

A polypeptide of the present invention may be a bacterial polypeptide. For example, the polypeptide may be a gram-positive bacterial polypeptide such as a Bacillus, Clostridium, Enterococcus, Geobacillus, Lactobacillus, Lactococcus, Oceanobacillus, Staphylococcus, Streptococcus, or Streptomyces polypeptide having metalloprotease activity, or a gram-negative bacterial polypeptide such as a Campylobacter, E. coli, Flavobacterium, Fusobacterium, Helicobacter, Ilyobacter, Neisseria, Pseudomonas, Salmonella, Ureaplasma polypeptide.

In one aspect, the polypeptide is a Bacillus alkalophilus, Bacillus amyloliquefaciens, Bacillus brevis, Bacillus cereus, Bacillus circulans, Bacillus clausii, Bacillus coagulans, Bacillus firmus, Bacillus lautus, Bacillus lentus, Bacillus licheniformis, Bacillus megaterium, Bacillus pumilus, Bacillus stearothermophilus, Bacillus subtilis, or Bacillus thuringiensis polypeptide.

In another aspect, the polypeptide is a Geobacillus caldolyticus, Geobacillus stearothermophilus polypeptide.

In another aspect, the polypeptide is a Streptococcus equisimilis, Streptococcus pyogenes, Streptococcus uberis, or Streptococcus equi subsp. Zooepidemicus polypeptide.

In another aspect, the polypeptide is a Streptomyces achromogenes, Streptomyces avermitilis, Streptomyces coelicolor, Streptomyces griseus, or Streptomyces lividans polypeptide.

A polypeptide of the present invention may also be a fungal polypeptide, and more preferably a yeast polypeptide such as a Candida, Kluyveromyces, Pichia, Saccharomyces, Schizosaccharomyces, or Yarrowia polypeptide; or more preferably a filamentous fungal polypeptide such as an Acremonium, Aspergillus, Aureobasidium, Chaetomium, Cryptococcus, Filibasidium, Fusarium, Humicola, Magnaporthe, Mucor, Myceliophthora, Neocallimastix, Neurospora, Paecilomyces, Penicillium, Piromyces, Poronia, Schizophyllum, Talaromyces, Thermoascus, Thielavia, Tolypocladium, Trichoderma or Verticillium polypeptide.

In a preferred aspect, the polypeptide is a Saccharomyces carlsbergensis, Saccharomyces cerevisiae, Saccharomyces diastaticus, Saccharomyces douglasii, Saccharomyces kluyveri, Saccharomyces norbensis, or Saccharomyces oviformis polypeptide.

In another preferred aspect, the polypeptide is an Aspergillus aculeatus, Aspergillus awamori, Aspergillus fumigatus, Aspergillus foetidus, Aspergillus japonicus, Aspergillus nidulans, Aspergillus niger, Aspergillus oryzae, Aspergillus terreus, Chaetomium globosum, Coprinus cinereus, Diplodia gossyppina, Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sporotrichioides, Fusarium sulphureum, Fusarium torulosum, Fusarium trichothecioides, Fusarium venenatum, Humicola insolens, Humicola lanuginosa, Magnaporthe grisea, Mucor miehei, Myceliophthora thermophila, Neurospora crassa, Penicillium purpurogenum, Phanerochaete chrysosporium, Poronia punctata, Pseudoplectania nigrella, Thermoascus aurantiacus, Thielavia terrestris, Trichoderma harzianum, Trichoderma koningii, Trichoderma longibrachiatum, Trichoderma reesei, Trichoderma viride, Trichophaea saccata or Verticillium tenerum polypeptide.

In a preferred aspect, the polypeptide is a Bacillus caldolyticus, a Bacillus cereus, a Bacillius megaterium, or a Geobacillus stearothermophilus polypeptide.

It will be understood that for the aforementioned species the invention encompasses both the perfect and imperfect states, and other taxonomic equivalents, e.g., anamorphs, regardless of the species name by which they are known. Those skilled in the art will readily recognize the identity of appropriate equivalents.

Strains of these species are readily accessible to the public in a number of culture collections, such as the American Type Culture Collection (ATCC), Deutsche Sammlung von Mikroorganismen and Zellkulturen GmbH (DSM), Centraalbureau Voor Schimmelcultures (CBS), and Agricultural Research Service Patent Culture Collection, Northern Regional Research Center (NRRL).

Furthermore, such polypeptides may be identified and obtained from other sources including microorganisms isolated from nature (e.g., soil, composts, water, etc.) using the above-mentioned probes. Techniques for isolating microorganisms from natural habitats are well known in the art. The polynucleotide may then be obtained by similarly screening a genomic or cDNA library of such a microorganism. Once a polynucleotide sequence encoding a polypeptide has been detected with the probe(s), the polynucleotide can be isolated or cloned by utilizing techniques which are well known to those of ordinary skill in the art (see, e.g., Sambrook et al., 1989, supra).

Polypeptides of the present invention also include fused polypeptides or cleavable fusion polypeptides in which another polypeptide is fused at the N-terminus or the C-terminus of the polypeptide or fragment thereof. A fused polypeptide is produced by fusing a nucleotide sequence (or a portion thereof) encoding another polypeptide to a nucleotide sequence (or a portion thereof) of the present invention. Techniques for producing fusion polypeptides are known in the art, and include ligating the coding sequences encoding the polypeptides so that they are in frame and that expression of the fused polypeptide is under control of the same promoter(s) and terminator.

### Compositions

The present invention also relates to compositions comprising a Thermolysin-Like Metalloprotease. Preferably, the compositions are enriched in a Thermolysin-Like Metalloprotease. The term “enriched” indicates that the protease activity of the composition has been increased, e.g., with an enrichment factor of at least 1.1.

In one embodiment, the present invention relates to compositions in particular to cleaning compositions and/or detergent compositions comprising a Thermolysin-Like Metalloprotease and a suitable carrier and/or excipient.

In one embodiment, the detergent composition may be adapted for specific uses such as laundry, in particular household laundry, dish washing or hard surface cleaning.

The detergent compositions of the invention may be formulated, for example, as a hand or machine laundry detergent composition including a laundry additive composition suitable for pre-treatment of stained fabrics and a rinse added fabric softener composition, or be formulated as a detergent composition for use in general household hard surface cleaning operations, or be formulated for hand or machine dishwashing operations. The detergent compositions of the invention may find use in hard surface cleaning, automatic dishwashing applications, as well as cosmetic applications such as dentures, teeth, hair and skin.

In a preferred embodiment, the detergent compositions comprise one or more conventional carrier(s) and/or excipient(s) such as those exemplified below.

The detergent composition of the invention may be in any convenient form, e.g., a bar, a tablet, a powder, a granule, a paste or a liquid. A liquid detergent may be aqueous, typically containing up to 70% water and 0-30% organic solvent, or non-aqueous.

Unless otherwise noted, all component or composition levels provided herein are made in reference to the active level of that component or composition, and are exclusive of impurities, for example, residual solvents or by-products, which may be present in commercially available sources.

The Thermolysin-Like Metalloproteases are normally incorporated in the detergent composition at a level of from 0.000001% to 2% of enzyme protein by weight of the composition, preferably at a level of from 0.00001% to 1% of enzyme protein by weight of the composition, more preferably at a level of from 0.0001% to 0.75% of enzyme protein by weight of the composition, even more preferably at a level of from 0.001% to 0.5% of enzyme protein by weight of the composition.

Furthermore, the Thermolysin-Like Metalloproteases are normally incorporated in the detergent composition in such amounts that their concentration in the wash water is at a level of from 0.0000001% to 1% enzyme protein, preferably at a level of from 0.000005% to 0.01% of enzyme protein, more preferably at a level of from 0.000001% to 0.005% of enzyme protein, even more preferably at a level of from 0.00001% to 0.001% of enzyme protein in wash water.

As is well known, the amount of enzyme will also vary according to the particular application and/or as a result of the other components included in the compositions.

A composition for use in automatic dishwash (ADW), for example, may include 0.001%-50%, such as 0.01%-25%, such as 0.02%-20%, such as 0.1-15% of enzyme protein by weight of the composition.

A composition for use in laundry granulation, for example, may include 0.0001%-50%, such as 0.001%-20%, such as 0.01%-15%, such as 0.05%-10% of enzyme protein by weight of the composition.

A composition for use in laundry liquid, for example, may include 0.0001%-10%, such as 0.001-7%, such as 0.1%-5% of enzyme protein by weight of the composition.

In some preferred embodiments, the detergent compositions provided herein are typically formulated such that, during use in aqueous cleaning operations, the wash water has a pH of from about 5.0 to about 11.5, or in alternative embodiments, even from about 6.0 to about 10.5, such as from about 5 to about 11, from about 5 to about 10, from about 5 to about 9, from about 5 to about 8, from about 5 to about 7, from about 6 to about 11, from about 6 to about 10, from about 6 to about 9, from about 6 to about 8, from about 6 to about 7, from about 7 to about 11, from about 7 to about 10, from about 7 to about 9, or from about 7 to about 8. In some preferred embodiments, granular or liquid laundry products are formulated such that the wash water has a pH from about 5.5 to about 8. Techniques for controlling pH at recommended usage levels include the use of buffers, alkalis, acids, etc., and are well known to those skilled in the art.

Enzyme components weights are based on total active protein. All percentages and ratios are calculated by weight unless otherwise indicated. All percentages and ratios are calculated based on the total composition unless otherwise indicated. In the exemplified detergent composition, the enzymes levels are expressed by pure enzyme by weight of the total composition and unless otherwise specified, the detergent ingredients are expressed by weight of the total composition.

The enzymes of the present invention also find use in detergent additive products. A detergent additive product comprising a Thermolysin-Like Metalloprotease is ideally suited for inclusion in a wash process when, e.g., temperature is low, the pH is between 6 and 8 and the washing time short, e.g., below 30 min.

The detergent additive product may be a Thermolysin-Like Metalloprotease and preferably an additional enzyme. In one embodiment, the additive is packaged in dosage form for addition to a cleaning process. The single dosage may comprise a pill, tablet, gelcap or other single dosage unit including powders and/or liquids. In some embodiments, filler and/or carrier material(s) are included, suitable filler or carrier materials include, but are not limited to, various salts of sulfate, carbonate and silicate as well as talc, clay and the like. In some embodiments filler and/or carrier materials for liquid compositions include water and/or low molecular weight primary and secondary alcohols including polyols and diols. Examples of such alcohols include, but are not limited to, methanol, ethanol, propanol and isopropanol.

In one particularly preferred embodiment the metalloprotease according to the invention is employed in a granular composition or liquid, the metalloprotease may be in form of an encapsulated particle. In one embodiment, the encapsulating material is selected from the group consisting of carbohydrates, natural or synthetic gums, chitin and chitosan, cellulose and cellulose derivatives, silicates, phosphates, borates, polyvinyl alcohol, polyethylene glycol, paraffin waxes and combinations thereof.

The compositions according to the invention typically comprise one or more detergent ingredients. The term detergent compositions include articles and cleaning and treatment compositions. The term cleaning composition includes, unless otherwise indicated, tablet, granular or powder-form all-purpose or “heavy-duty” washing agents, especially laundry detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use. The composition can also be in unit dose packages, including those known in the art and those that are water soluble, water insoluble and/or water permeable.

In embodiments in which cleaning and/or detergent components may not be compatible with the metalloprotease of the present invention, suitable methods may be used for keeping the cleaning and/or detergent components and the metalloprotease separated (i.e., not in contact with each other) until combination of the two components is appropriate. Such separation methods include any suitable method known in the art (e.g., gelcaps, encapsulation, tablets, physical separation).

As mentioned when the metalloprotease of the invention is employed as a component of a detergent composition (e.g., a laundry washing detergent composition, or a dishwashing detergent composition), it may, for example, be included in the detergent composition in the form of a non-dusting granulate, a stabilized liquid, or a protected enzyme. Non-dusting granulates may be produced, e.g., as disclosed in U.S. Pat. Nos. 4,106,991 and 4,661,452 (both to Novo Industri A/S) and may optionally be coated by methods known in the art. Examples of waxy coating materials are poly (ethylene oxide) products (polyethyleneglycol, PEG) with mean molecular weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591.

In some embodiments, the enzymes employed herein are stabilized by the presence of water-soluble sources of zinc (II), calcium (II) and/or magnesium (II) ions in the finished compositions that provide such ions to the enzymes, as well as other metal ions (e.g., barium (II), scandium (II), iron (II), manganese (II), aluminum (III), Tin (II), cobalt (II), copper (II), Nickel (II), and oxovanadium (IV)). The enzymes of the detergent compositions of the invention may also be stabilized using conventional stabilizing agents such as polyol, e.g., propylene glycol or glycerol, a sugar or sugar alcohol, lactic acid, and the composition may be formulated as described in, e.g., WO 92/19709 and WO 92/19708. The enzymes of the invention may also be stabilized by adding reversible enzyme inhibitors, e.g., of the protein type (as described in EP 0 544 777 B1) or the boronic acid type. Other enzyme stabilizers are well known in the art, such as peptide aldehydes and protein hydrolysate, e.g. the metalloproteases according to the invention may be stabilized using peptide aldehydes or ketones such as described in WO2005/105826 and WO2009/118375.

Protected enzymes for inclusion in a detergent composition of the invention may be prepared, as mentioned above, according to the method disclosed in EP 238 216.

The composition may be augmented with one or more agents for preventing or removing the formation of the biofilm. These agents may include, but are not limited to, dispersants, surfactants, detergents, other enzymes, anti-microbials, and biocides.

### Other Enzymes

In one embodiment, a Thermolysin-Like Metalloprotease is combined with one or more enzymes, such as at least two enzymes, more preferred at least three, four or five enzymes. Preferably, the enzymes have different substrate specificity, e.g., proteolytic activity, amylolytic activity, lipolytic activity, hemicellulytic activity or pectolytic activity.

The detergent additive as well as the detergent composition may comprise one or more enzymes such as a protease, lipase, cutinase, an amylase, carbohydrase, cellulase, pectinase, mannanase, arabinase, galactanase, xylanase, oxidase, e.g., a laccase and/or peroxidase.

In general the properties of the selected enzyme(s) should be compatible with the selected detergent, (i.e., pH-optimum, compatibility with other enzymatic and non-enzymatic ingredients, etc.), and the enzyme(s) should be present in effective amounts.

### Cellulases:

Suitable cellulases include those of animal, vegetable or microbial origin. Particularly suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. No. 4,435,307, U.S. Pat. No. 5,648,263, U.S. Pat. No. 5,691,178, U.S. Pat. No. 5,776,757 and WO 89/09259.

Especially suitable cellulases are the alkaline or neutral cellulases having color care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, U.S. Pat. No. 5,686,593, U.S. Pat. No. 5,763,254, WO 95/24471, WO 98/12307 and WO 1999/001544.

Commercially available cellulases include Celluzyme™, and Carezyme™ (Novozymes A/S), Clazinase™, and Puradax HA™ (Genencor International Inc.), and KAC-500(B)™ (Kao Corporation).

### Peptidases and Proteases:

Suitable peptidases and proteases include those of animal, vegetable or microbial origin. Microbial origin is preferred. Chemically modified or protein engineered mutants are included. The protease may be a serine protease or a metalloprotease, preferably an alkaline microbial protease or a trypsin-like protease. Examples of alkaline proteases are subtilisins, especially those derived from Bacillus, e.g., subtilisin Novo, subtilisin Carlsberg, subtilisin 309, subtilisin 147 and subtilisin 168 (described in WO 89/06279). Examples of trypsin-like proteases are trypsin (e.g., of porcine or bovine origin) and the Fusarium protease described in WO 89/06270 and WO 94/25583.

Examples of useful proteases are the variants described in WO 92/19729, WO 98/20115, WO 98/20116, and WO 98/34946, especially the variants with substitutions in one or more of the following positions: 27, 36, 57, 76, 87, 97, 101, 104, 120, 123, 167, 170, 194, 206, 218, 222, 224, 235, and 274.

Preferred commercially available protease enzymes include Alcalase™, Savinase™ Primase™, Duralase™, Esperase™, Kannase™, Ovozyme™, Polarzyme™, Everlase™, Coronase™ and Relase™ (Novozymes A/S), Maxatase™, Maxacal™, Maxapem™, Properase™, Purafect™, Purafect OxP™, FN2™, and FN3™ (Genencor International Inc.).

### Lipases:

Suitable lipases include those of animal, vegetable or microbial origin. Particularly suitable lipases include those of bacterial or fungal origin. Chemically modified or protein engineered mutants are included. Examples of useful lipases include lipases from Humicola (synonym Thermomyces), e.g., from H. lanuginosa (T. lanuginosus) as described in EP 258 068 and EP 305 216 or from H. insolens as described in WO 96/13580, a Pseudomonas lipase, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g., from B. subtilis (Dartois et al., 1993, Biochemica et Biophysica Acta, 1131: 253-360), B. stearothermophilus (JP 64/744992) or B. pumilus (WO 91/16422).

Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202.

Preferred commercially available lipase enzymes include Lipolase™, Lipolase Ultra™ and Lipex™ (Novozymes A/S).

### Amylases:

Suitable amylases include those of animal, vegetable or microbial origin. Particularly suitable amylases (alpha and/or beta) include those of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Examples of useful amylases are the variants described in WO 94/02597, WO 94/18314, WO 96/23873, and WO 97/43424, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444.

Commercially available amylases are Duramyl™, Termamyl™, Fungamyl™ and BAN™ (Novozymes A/S), Rapidase™ and Purastar™ (from Genencor International Inc.).

### Peroxidases/Oxidases:

Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257.

Commercially available peroxidases include Guardzyme™ (Novozymes A/S).

The detergent enzyme(s) may be included in a detergent composition by adding separate additives containing one or more enzymes, or by adding a combined additive comprising all of these enzymes. A detergent additive of the invention, i.e., a separate additive or a combined additive, can be formulated, for example, as a granulate, liquid, slurry, etc. Preferred detergent additive formulations are granulates, in particular non-dusting granulates as described above, liquids, in particular stabilized liquids, or slurries.

### Surfactants

Typically, the detergent composition comprises (by weight of the composition) one or more surfactants in the range of 0% to 50%, preferably from 2% to 40%, more preferably from 5% to 35%, more preferably from 7% to 30%, most preferably from 10% to 25%, even most preferably from 15% to 20%. In a preferred embodiment the detergent is a liquid or powder detergent comprising less than 40%, preferably less than 30%, more preferably less than 25%, even more preferably less than 20% by weight of surfactant. The composition may comprise from 1% to 15%, preferably from 2% to 12%, 3% to 10%, most preferably from 4% to 8%, even most preferably from 4% to 6% of one or more surfactants. Preferred surfactants are anionic surfactants, non-ionic surfactants, cationic surfactants, zwitterionic surfactants, amphoteric surfactants, and mixtures thereof. Preferably, the major part of the surfactant is anionic. Suitable anionic surfactants are well known in the art and may comprise fatty acid carboxylates (soap), branced-chain, linear-chain and random chain alkyl sulfates or fatty alcohol sulfates or primary alcohol sulfates or alkyl benzenesulfonates such as LAS and LAB or phenylalknesulfonates or alkenyl sulfonates or alkenyl benzenesulfonates or alkyl ethoxysulfates or fatty alcohol ether sulfates or alpha-olefin sulfonate or dodecenyl/tetradecnylsuccinic acid. The anionic surfactants may be alkoxylated. The detergent composition may also comprise from 1 wt % to 10 wt % of non-ionic surfactant, preferably from 2 wt % to 8 wt %, more preferably from 3 wt % to 7 wt %, even more preferably less than 5 wt % of non-ionic surfactant. Suitable non-ionic surfactants are well known in the art and may comprise alcohol ethoxylates, and/or alkyl ethoxylates, and/or alkylphenol ethoxylates, and/or glucamides such as fatty acid N-glucosyl N-methyl amides, and/or alkyl polyglucosides and/or mono- or diethanolamides or fatty acid amides. The detergent composition may also comprise from 0 wt % to 10 wt % of cationic surfactant, preferably from 0.1 wt % to 8 wt %, more preferably from 0.5 wt % to 7 wt %, even more preferably less than 5 wt % of cationic surfactant. Suitable cationic surfactants are well known in the art and may comprise alkyl quaternary ammonium compounds, and/or alkyl pyridinium compounds and/or alkyl quaternary phosphonium compounds and/or alkyl ternary sulphonium compounds. The composition preferably comprises surfactant in an amount to provide from 100 ppm to 5,000 ppm surfactant in the wash liquor during the laundering process. The composition upon contact with water typically forms a wash liquor comprising from 0.5 g/l to 10 g/l detergent composition. Many suitable surface active compounds are available and fully described in the literature, for example, in “SurfaceActive Agents and Detergents”, Volumes 1 and 11, by Schwartz, Perry and Berch.

### Builders

The main role of builder is to sequester divalent metal ions (such as calcium and magnesium ions) from the wash solution that would otherwise interact negatively with the surfactant system. Builders are also effective at removing metal ions and inorganic soils from the fabric surface, leading to improved removal of particulate and beverage stains. Builders are also a source of alkalinity and buffer the pH of the wash water to a level of 9.5 to 11. The buffering capacity is also termed reserve alkalinity, and should preferably be greater than 4.

The detergent compositions of the present invention may comprise one or more detergent builders or builder systems. Many suitable builder systems are described in the literature, for example in Powdered Detergents, Surfactant science series volume 71, Marcel Dekker, Inc. Builder may comprise from 0% to 60%, preferably from 5% to 45%, more preferably from 10% to 40%, most preferably from 15% to 35%, even more preferably from 20% to 30% builder by weight of the subject composition. The composition may comprise from 0% to 15%, preferably from 1% to 12%, 2% to 10%, most preferably from 3% to 8%, even most preferably from 4% to 6% of builder by weight of the subject composition.

Builders include, but are not limited to, the alkali metal, ammonium and alkanolammonium salts of polyphosphates (e.g., tripolyphosphate STPP), alkali metal silicates, alkaline earth and alkali metal carbonates, aluminosilicate builders (e.g., zeolite) and polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof. Ethanole amines (MEA, DEA, and TEA may also contribute to the buffering capacity in liquid detergents.

### Bleaches

The detergent compositions of the present invention may comprise one or more bleaching agents. In particular powdered detergents may comprise one or more bleaching agents. Suitable bleaching agents include other photobleaches, pre-formed peracids, sources of hydrogen peroxide, bleach activators, hydrogen peroxide, bleach catalysts and mixtures thereof. In general, when a bleaching agent is used, the compositions of the present invention may comprise from about 0.1% to about 50% or even from about 0.1% to about 25% bleaching agent by weight of the subject cleaning composition. Examples of suitable bleaching agents include:

(1) other photobleaches for example Vitamin K3;

(2) preformed peracids: Suitable preformed peracids include, but are not limited to, compounds selected from the group consisting of percarboxylic acids and salts, percarbonic acids and salts, perimidic acids and salts, peroxymonosulfuric acids and salts, for example, Oxone, and mixtures thereof. Suitable percarboxylic acids include hydrophobic and hydrophilic peracids having the formula R—(C═O)O—O-M wherein R is an alkyl group, optionally branched, having, when the peracid is hydrophobic, from 6 to 14 carbon atoms, or from 8 to 12 carbon atoms and, when the peracid is hydrophilic, less than 6 carbon atoms or even less than 4 carbon atoms; and M is a counterion, for example, sodium, potassium or hydrogen;

(3) sources of hydrogen peroxide, for example, inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts are selected from the group consisting of sodium salts of perborate, percarbonate and mixtures thereof. When employed, inorganic perhydrate salts are typically present in amounts of from 0.05 to 40 wt %, or 1 to 30 wt % of the overall composition and are typically incorporated into such compositions as a crystalline solid that may be coated. Suitable coatings include inorganic salts such as alkali metal silicate, carbonate or borate salts or mixtures thereof, or organic materials such as water-soluble or dispersible polymers, waxes, oils or fatty soaps. Useful bleaching compositions are described in U.S. Pat. Nos. 5,576,282, and 6,306,812;

(4) bleach activators having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof—especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethyllene diamine (TAED) and nonanoyloxybenzene sulphonate (NOBS). Suitable bleach activators are also disclosed in WO 98/17767. While any suitable bleach activator may be employed, in one aspect of the invention the subject cleaning composition may comprise NOBS, TAED or mixtures thereof; and

(5) bleach catalysts that are capable of accepting an oxygen atom from peroxyacid and transferring the oxygen atom to an oxidizable substrate are described in WO 2008/007319. Suitable bleach catalysts include, but are not limited to: iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones and mixtures thereof. The bleach catalyst will typically be comprised in the detergent composition at a level of from 0.0005% to 0.2%, from 0.001% to 0.1%, or even from 0.005% to 0.05% by weight.

When present, the peracid and/or bleach activator is generally present in the composition in an amount of from about 0.1 to about 60 wt %, from about 0.5 to about 40 wt % or even from about 0.6 to about 10 wt % based on the composition. One or more hydrophobic peracids or precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or even 2:1 to 10:1.

### Adjunct Materials

Dispersants—The detergent compositions of the present invention can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

Dye Transfer Inhibiting Agents—The detergent compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

Fluorescent whitening agent—The detergent compositions of the present invention will preferably also contain additional components that may tint articles being cleaned, such as fluorescent whitening agent or optical brighterners. Any fluorescent whitening agent suitable for use in a laundry detergent composition may be used in the composition of the present invention. The most commonly used fluorescent whitening agents are those belonging to the classes of diaminostilbene-sulphonic acid derivatives, diarylpyrazoline derivatives and bisphenyl-distyryl derivatives. Examples of the diaminostilbene-sulphonic acid derivative type of fluorescent whitening agents include the sodium salts of:
4,4′-bis-(2-diethanolamino-4-anilino-s-triazin-6-ylamino)stilbene-2,2′-disulphonate,
4,4′-bis-(2,4-dianilino-s-triazin-6-ylamino)stilbene-2,2′-disulphonate,
4,4′-bis-(2-anilino-4(N-methyl-N-2-hydroxy-ethylamino)-s-triazin-6-ylamino)stilbene-2,2′-disulphonate,
4,4′-bis-(4-phenyl-2,1,3-triazol-2-yl)stilbene-2,2′-disulphonate,
4,4′-bis-(2-anilino-4(1-methyl-2-hydroxy-ethylamino)-s-triazin-6-ylamino) stilbene-2,2′-disulphonate and,
2-(stilbyl-4″-naptho-1,2′:4,5)-1,2,3-trizole-2″-sulphonate. Preferred fluorescent whitening agents are Tinopal DMS and Tinopal CBS available from Ciba-Geigy AG, Base1, Switzerland. Tinopal DMS is the disodium salt of 4,4′-bis-(2-morpholino-4 anilino-s-triazin-6-ylamino) stilbene disulphonate. Tinopal CBS is the disodium salt of 2,2′-bis-(phenyl-styryl)disulphonate.

Also preferred are fluorescent whitening agents is the commercially available Parawhite KX, supplied by Paramount Minerals and Chemicals, Mumbai, India.

Other fluorescers suitable for use in the invention include the 1-3-diaryl pyrazolines and the 7-alkylaminocoumarins.
Suitable fluorescent brightener levels include lower levels of from about 0.01, from 0.05, from about 0.1 or even from about 0.2 wt % to upper levels of 0.5 or even 0.75 wt %.

Fabric hueing agents—The detergent compositions of the present invention may also include fabric hueing agents such as dyes or pigments which when formulated in detergent compositions can deposit onto a fabric when said fabric is contacted with a wash liquor comprising said detergent compositions thus altering the tint of said fabric through absorption of visible light. Fluorescent whitening agents emit at least some visible light. In contrast, fabric hueing agents alter the tint of a surface as they absorb at least a portion of the visible light spectrum. Suitable fabric hueing agents include dyes and dye-clay conjugates, and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, for example as described in WO 2005/03274, WO 2005/03275, WO 2005/03276 and EP 1 876 226. The detergent composition preferably comprises from about 0.00003 wt % to about 0.2 wt %, from about 0.00008 wt % to about 0.05 wt %, or even from about 0.0001 wt % to about 0.04 wt % fabric hueing agent. The composition may comprise from 0.0001 wt % to 0.2 wt % fabric hueing agent, this may be especially preferred when the composition is in the form of a unit dose pouch.

Soil release polymers—The detergent compositions of the present invention may also include one or more soil release polymers which aid the removal of soils from fabrics such as cotton and polyester based fabrics, in particular the removal of hydrophobic soils from polyester based fabrics. The soil release polymers may for example be nonionic or anionic terephthalte based polymers, polyvinyl caprolactam and related copolymers, vinyl graft copolymers, polyester polyamides see for example Chapter 7 in Powdered Detergents, Surfactant science series, volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523. Furthermore random graft co-polymers are suitable soil release polymers Suitable graft co-polymers are described in more detail in WO 2007/138054, WO 2006/108856 and WO 2006/113314. Other soil release polymers are substituted polysaccharide structures especially substituted cellulosic structures such as modified cellulose deriviatives such as those described in EP 1 867 808 or WO 2003/040279. Suitable cellulosic polymers include cellulose, cellulose ethers, cellulose esters, cellulose amides and mixtures thereof. Suitable cellulosic polymers include anionically modified cellulose, nonionically modified cellulose, cationically modified cellulose, zwitterionically modified cellulose, and mixtures thereof. Suitable cellulosic polymers include methyl cellulose, carboxy methyl cellulose, ethyl cellulose, hydroxylethyl cellulose, hydroxylpropyl methyl cellulose, ester carboxy methyl cellulose, and mixtures thereof.

Anti-redeposition agents—The detergent compositions of the present invention may also include one or more anti-redeposition agents such as carboxymethylcellulose (CMC), polyvinyl alcohol (PVA), polyvinylpyrrolidone (PVP), polyoxyethylene and/or polyethyleneglycol (PEG), homopolymers of acrylic acid, copolymers of acrylic acid and maleic acid, and ethoxylated polyethyleneimines. The cellulose based polymers described under soil release polymers above may also function as anti-redeposition agents.

Other suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, sod suppressors, solvents, structurants for liquid detergents and/or structure elasticizing agents.

In one aspect the detergent is a compact fluid laundry detergent composition comprising: a) at least about 10%, preferably from 20 to 80% by weight of the composition, of surfactant selected from anionic surfactants, non ionic surfactants, soap and mixtures thereof; b) from about 1% to about 30%, preferably from 5 to 30%, by weight of the composition, of water; c) from about 1% to about 15%, preferably from 3 to 10% by weight of the composition, of non-aminofunctional solvent; and d) from about 5% to about 20%, by weight of the composition, of a performance additive selected from chelants, soil release polymers, enzymes and mixtures thereof; wherein the compact fluid laundry detergent composition comprises at least one of: (i) the surfactant has a weight ratio of the anionic surfactant to the nonionic surfactant from about 1.5:1 to about 5:1, the surfactant comprises from about 15% to about 40%, by weight of the composition, of anionic surfactant and comprises from about 5% to about 40%, by weight of the composition, of the soap; (ii) from about 0.1% to about 10%, by weight of the composition, of a suds boosting agent selected from suds boosting polymers, cationic surfactants, zwitterionic surfactants, amine oxide surfactants, amphoteric surfactants, and mixtures thereof; and (ii) both (i) and (ii). All the ingredients are described in WO 2007/130562. Further polymers useful in detergent formulations are described in WO 2007/149806.

In another aspect the detergent is a compact granular (powdered) detergent comprising a) at least about 10%, preferably from 15 to 60% by weight of the composition, of surfactant selected from anionic surfactants, non ionic surfactants, soap and mixtures thereof; b) from about 10 to 80% by weight of the composition, of a builder, preferably from 20% to 60% where the builder may be a mixture of builders selected from i) phosphate builder, preferably less than 20%, more preferably less than 10% even more preferably less than 5% of the total builder is a phosphate builder; ii) a zeolite builder, preferably less than 20%, more preferably less than 10% even more preferably less than 5% of the total builder is a zeolite builder; iii) citrate, preferably 0 to 5% of the total builder is a citrate builder; iv) polycarboxylate, preferably 0 to 5% of the total builder is a polycarboxylate builder v) carbonate, preferably 0 to 30% of the total builder is a carbonate builder and yl) sodium silicates, preferably 0 to 20% of the total builder is a sodium silicate builder; c) from about 0% to 25% by weight of the composition, of fillers such as sulphate salts, preferably from 1% to 15%, more preferably from 2% to 10%, more preferably from 3% to 5% by weight of the composition, of fillers; and d) from about 0.1% to 20% by weight of the composition, of enzymes, preferably from 1% to 15%, more preferably from 2% to 10% by weight of the composition, of enzymes.

### Use of Thermolysin-Like Metalloproteases in Detergents

The soils and stains that are important for detergent formulators are composed of many different substances, and a range of different enzymes, all with different substrate specificities have been developed for use in detergents both in relation to laundry and hard surface cleaning, such as dishwashing. These enzymes are considered to provide an enzyme detergency benefit, since they specifically improve stain removal in the cleaning process they are applied in as compared to the same process without enzymes. Stain removing enzymes that are known in the art include enzymes such as carbohydrases, amylases, proteases, lipases, cellulases, hemicellulases, xylanases, cutinases, and pectinase.

In one aspect, the present invention concerns the use of Thermolysin-Like Metalloproteases in detergent compositions and cleaning processes, such as laundry and hard surface cleaning. Thus, in one aspect, the present invention demonstrates the detergency effect of a variety of exemplary Thermolysin-Like Metalloproteases on various stains and under various conditions. In a particular aspect of the invention the detergent composition and the use in cleaning process concerns the use of a Thermolysin-Like Metalloprotease together with at least one of the above mentioned stain removal enzymes, such as another protease, and in particular a serine protease.

In a preferred aspect of the present invention the Thermolysin-Like Metalloproteases useful according to the invention may be combined with at least two enzymes. These additional enzymes are described in details in the section “other enzymes”, more preferred at least three, four or five enzymes. Preferably, the enzymes have different substrate specificity, e.g., carbolytic activity, proteolytic activity, amylolytic activity, lipolytic activity, hemicellulytic activity or pectolytic activity. The enzyme combination may for example be a Thermolysin-Like Metalloprotease with another stain removing enzyme, e.g., a Thermolysin-Like Metalloprotease and a protease, a Thermolysin-Like Metalloprotease and an amylase, a Thermolysin-Like Metalloprotease and a cellulase, a Thermolysin-Like Metalloprotease and a hemicellulase, a Thermolysin-Like Metalloprotease and a lipase, a Thermolysin-Like Metalloprotease and a cutinase, a Thermolysin-Like Metalloprotease and a pectinase or a Thermolysin-Like Metalloprotease and an anti-redeposition enzyme. More preferably, the Thermolysin-Like Metalloprotease is combined with at least two other stain removing enzymes, e.g., a Thermolysin-Like Metalloprotease, a lipase and an amylase; or a Thermolysin-Like Metalloprotease, a protease and an amylase; or a Thermolysin-Like Metalloprotease, a protease and a lipase; or a Thermolysin-Like Metalloprotease, a protease and a pectinase; or a Thermolysin-Like Metalloprotease, a protease and a cellulase; or a Thermolysin-Like Metalloprotease, a protease and a hemicellulase; or a Thermolysin-Like Metalloprotease, a protease and a cutinase; or a Thermolysin-Like Metalloprotease, an amylase and a pectinase; or a Thermolysin-Like Metalloprotease, an amylase and a cutinase; or a Thermolysin-Like Metalloprotease, an amylase and a cellulase; or a Thermolysin-Like Metalloprotease, an amylase and a hemicellulase; or a Thermolysin-Like Metalloprotease, a lipase and a pectinase; or a Thermolysin-Like Metalloprotease, a lipase and a cutinase; or a Thermolysin-Like Metalloprotease, a lipase and a cellulase; or a Thermolysin-Like Metalloprotease, a lipase and a hemicellulase. Even more preferably, a Thermolysin-Like Metalloprotease may be combined with at least three other stain removing enzymes, e.g., a Thermolysin-Like Metalloprotease, a protease, a lipase and an amylase; or a Thermolysin-Like Metalloprotease, a protease, an amylase and a pectinase; or a Thermolysin-Like Metalloprotease, a protease, an amylase and a cutinase; or a Thermolysin-Like Metalloprotease, a protease, an amylase and a cellulase; or a Thermolysin-Like Metalloprotease, a protease, an amylase and a hemicellulase; or a Thermolysin-Like Metalloprotease, an amylase, a lipase and a pectinase; or a Thermolysin-Like Metalloprotease, an amylase, a lipase and a cutinase; or a Thermolysin-Like Metalloprotease, an amylase, a lipase and a cellulase; or a Thermolysin-Like Metalloprotease, an amylase, a lipase and a hemicellulase; or a Thermolysin-Like Metalloprotease, a protease, a lipase and a pectinase; or a Thermolysin-Like Metalloprotease, a protease, a lipase and a cutinase; or a Thermolysin-Like Metalloprotease, a protease, a lipase and a cellulase; or a Thermolysin-Like Metalloprotease, a protease, a lipase and a hemicellulase. A Thermolysin-Like Metalloprotease useful according to the present invention may be combined with any of the enzymes selected from the non-exhaustive list comprising: carbohydrases, such as an amylase, a hemicellulase, a pectinase, a cellulase, a xanthanase or a pullulanase, a peptidase, a protease or a lipase.

In a preferred embodiment, a Thermolysin-Like Metalloprotease is combined with a serine protease, e.g., an S8 family protease such as Savinase.

In another embodiment of the present invention, a Thermolysin-Like Metalloprotease useful according to the present invention may be combined with one or more other metalloproteases, such as another M4 Metalloprotease, including Neutrase™ or Thermolysin. Such combinations may further comprise combinations of the other detergent enzymes as outlined above.

The cleaning process or the textile care process may for example be a laundry process, a dishwashing process or cleaning of hard surfaces such as bathroom tiles, floors, table tops, drains, sinks and washbasins. Laundry processes can for example be household laundering, but it may also be industrial laundering. Furthermore, the invention relates to a process for laundering of fabrics and/or garments where the process comprises treating fabrics with a washing solution containing a detergent composition, and at least one Thermolysin-Like Metalloprotease. The cleaning process or a textile care process can for example be carried out in a machine washing process or in a manual washing process. The washing solution can for example be an aqueous washing solution containing a detergent composition.

The fabrics and/or garments subjected to a washing, cleaning or textile care process of the present invention may be conventional washable laundry, for example household laundry. Preferably, the major part of the laundry is garments and fabrics, including knits, woven, denims, non-woven, felts, yarns, and towelling. The fabrics may be cellulose based such as natural cellulosics, including cotton, flax, linen, jute, ramie, sisal or coir or manmade cellulosics (e.g., originating from wood pulp) including viscose/rayon, ramie, cellulose acetate fibers (tricell), lyocell or blends thereof. The fabrics may also be non-cellulose based such as natural polyamides including wool, camel, cashmere, mohair, rabbit and silk or synthetic polymer such as nylon, aramid, polyester, acrylic, polypropylen and spandex/elastane, or blends thereof as well as blend of cellulose based and non-cellulose based fibers. Examples of blends are blends of cotton and/or rayon/viscose with one or more companion material such as wool, synthetic fibers (e.g., polyamide fibers, acrylic fibers, polyester fibers, polyvinyl alcohol fibers, polyvinyl chloride fibers, polyurethane fibers, polyurea fibers, aramid fibers), and cellulose-containing fibers (e.g., rayon/viscose, ramie, flax, linen, jute, cellulose acetate fibers, lyocell).

The last few years there has been an increasing interest in replacing components in detergents, which is derived from petrochemicals with renewable biological components such as enzymes and polypeptides without compromising the wash performance. When the components of detergent compositions change new enzyme activities or new enzymes having alternative and/or improved properties compared to the common used detergent enzymes such as proteases, lipases and amylases is needed to achieve a similar or improved wash performance when compared to the traditional detergent compositions.

The invention further concerns the use of Thermolysin-Like Metalloprotease in a proteinaceous stain removing processes. The proteinaceous stains may be stains such as food stains, e.g., baby food, sebum, cocoa, egg, blood, milk, ink, grass, or a combination hereof.

Typical detergent compositions includes various components in addition to the enzymes, these components have different effects, some components like the surfactants lower the surface tension in the detergent, which allows the stain being cleaned to be lifted and dispersed and then washed away, other components like bleach systems removes discolor often by oxidation and many bleaches also have strong bactericidal properties, and are used for disinfecting and sterilizing. Yet other components like builder and chelator softens, e.g., the wash water by removing the metal ions form the liquid.

In a particular embodiment, the invention concerns the use of a composition comprising a Thermolysin-Like Metalloprotease, wherein said enzyme composition further comprises at least one or more of the following a surfactant, a builder, a chelator or chelating agent, bleach system or bleach component in laundry or dish wash.

In a preferred embodiment of the invention the amount of a surfactant, a builder, a chelator or chelating agent, bleach system and/or bleach component are reduced compared to amount of surfactant, builder, chelator or chelating agent, bleach system and/or bleach component used without the added Thermolysin-Like Metalloprotease. Preferably the at least one component which is a surfactant, a builder, a chelator or chelating agent, bleach system and/or bleach component is present in an amount that is 1% less, such as 2% less, such as 3% less, such as 4% less, such as 5% less, such as 6% less, such as 7% less, such as 8% less, such as 9% less, such as 10% less, such as 15% less, such as 20% less, such as 25% less, such as 30% less, such as 35% less, such as 40% less, such as 45% less, such as 50% less than the amount of the component in the system without the addition of Thermolysin-Like Metalloprotease, such as a conventional amount of such component. In one aspect, the Thermolysin-Like Metalloprotease is used in detergent compositions wherein said composition is free of at least one component which is a surfactant, a builder, a chelator or chelating agent, bleach system or bleach component and/or polymer.

### Washing Method

The detergent compositions of the present invention are ideally suited for use in laundry applications. Accordingly, the present invention includes a method for laundering a fabric. The method comprises the steps of contacting a fabric to be laundered with a cleaning laundry solution comprising the detergent composition according to the invention. The fabric may comprise any fabric capable of being laundered in normal consumer use conditions. The solution preferably has a pH of from about 5.5 to about 8. The compositions may be employed at concentrations of from about 100 ppm, preferably 500 ppm to about 15,000 ppm in solution. The water temperatures typically range from about 5° C. to about 90° C., including about 10° C., about 15° C., about 20° C., about 25° C., about 30° C., about 35° C., about 40° C., about 45° C., about 50° C., about 55° C., about 60° C., about 65° C., about 70° C., about 75° C., about 80° C., about 85° C. and about 90° C. The water to fabric ratio is typically from about 1:1 to about 30:1.

In particular embodiments, the washing method is conducted at a pH of from about 5.0 to about 11.5, or in alternative embodiments, even from about 6 to about 10.5, such as about 5 to about 11, about 5 to about 10, about 5 to about 9, about 5 to about 8, about 5 to about 7, about 5.5 to about 11, about 5.5 to about 10, about 5.5 to about 9, about 5.5 to about 8, about 5.5. to about 7, about 6 to about 11, about 6 to about 10, about 6 to about 9, about 6 to about 8, about 6 to about 7, about 6.5 to about 11, about 6.5 to about 10, about 6.5 to about 9, about 6.5 to about 8, about 6.5 to about 7, about 7 to about 11, about 7 to about 10, about 7 to about 9, or about 7 to about 8, preferably about 5.5 to about 9, and more preferably about 6 to about 8.

In particular embodiments, the washing method is conducted at a degree of hardness of from about 0° dH to about 30° dH, such as about 1° dH, about 2° dH, about 3° dH, about 4° dH, about 5° dH, about 6° dH, about 7° dH, about 8° dH, about 9° dH, about 10° dH, about 11° dH, about 12° dH, about 13° dH, about 14° dH, about 15° dH, about 16° dH, about 17° dH, about 18° dH, about 19° dH, about 20° dH, about 21° dH, about 22° dH, about 23° dH, about 24° dH, about 25° dH, about 26° dH, about 27° dH, about 28° dH, about 29° dH, about 30° dH. Under typical European wash conditions, the degree of hardness is about 15° dH, under typical US wash conditions about 6° dH, and under typical Asian wash conditions, about 3° dH.

The present invention relates to a method of cleaning a fabric, a dishware or hard surface with a detergent composition comprising a Thermolysin-Like Metalloprotease.

A preferred embodiment concerns a method of cleaning, said method comprising the steps of: contacting an object with a cleaning composition comprising a Thermolysin-Like Metalloprotease under conditions suitable for cleaning said object. In a preferred embodiment the cleaning composition is a detergent composition and the process is a laundry or a dish wash process.

Still another embodiment relates to a method for removing stains from fabric which comprises contacting said a fabric with a composition comprising a Thermolysin-Like Metalloprotease under conditions suitable for cleaning said object.

In a preferred embodiment the compositions for use in the methods above further comprises at least one additional enzyme as set forth in the “other enzymes” section above, such as an enzyme selected from the group consisting of carbohydrases, peptidases, proteases, lipases, cellulase, xylanases or cutinases or a combination hereof. In yet another preferred embodiment the compositions comprises a reduced amount of at least one or more of the following components a surfactant, a builder, a chelator or chelating agent, bleach system or bleach component or a polymer.

Also contemplated are compositions and methods of treating fabrics (e.g., to desize a textile) using one or more of the metalloprotease of the invention. The metalloprotease can be used in any fabric-treating method which is well known in the art (see, e.g., U.S. Pat. No. 6,077,316). For example, in one aspect, the feel and appearance of a fabric is improved by a method comprising contacting the fabric with a metalloprotease in a solution. In one aspect, the fabric is treated with the solution under pressure.

In one embodiment, the metalloprotease is applied during or after the weaving of textiles, or during the desizing stage, or one or more additional fabric processing steps. During the weaving of textiles, the threads are exposed to considerable mechanical strain. Prior to weaving on mechanical looms, warp yarns are often coated with sizing starch or starch derivatives in order to increase their tensile strength and to prevent breaking. The metalloprotease can be applied to remove these sizing protein or protein derivatives. After the textiles have been woven, a fabric can proceed to a desizing stage. This can be followed by one or more additional fabric processing steps. Desizing is the act of removing size from textiles. After weaving, the size coating should be removed before further processing the fabric in order to ensure a homogeneous and wash-proof result. Also provided is a method of desizing comprising enzymatic hydrolysis of the size by the action of an enzyme.

### Low Temperature Uses

As previously stated, the Thermolysin-Like Metalloproteases are M4 Metalloproteases. The M4 Metalloproteases have also been termed the Thermolysin family because the M4 metalloprotease known as “Thermolysin” was the first characterized M4 metalloproteases and is one of the best characterized. The Thermolysins are known for their high temperature performance. High temperature performance is preferred, e.g., in processes for protein synthesis where the Thermolysins have been frequently used. Thus since the high temperature performance is advantageous in these processes thermostable variants of several Thermolysins have been made.

It was surprising, therefore, that some of the M4 metalloproteases—namely, the Thermolysin-Like Metalloproteases useful according to the present invention—were actually performing relatively better at low temperature, e.g., temperatures of about 40° C. or below than at higher temperatures, e.g., of about 60° C. or above when tested in AMSA as described in the below Examples.

Moreover, in a particularly preferred embodiment the Thermolysin-Like Metalloproteases perform relatively better than a subtilisin protease such as Savinase at a wash temperature of about 40° C. or below when tested in AMSA as described herein.

Thus, one embodiment of the invention concerns a method of doing laundry, dish wash or industrial cleaning comprising contacting a surface to be cleaned with a Thermolysin-Like Metalloprotease, and wherein said laundry, dish wash, industrial or institutional cleaning is performed at a temperature of about 40° C. or below. One embodiment of the invention relates to the use of a metalloprotease in laundry, dish wash or a cleaning process wherein the temperature in laundry, dish wash, industrial cleaning is about 40° C. or below

In another embodiment, the invention concerns the use of a metalloprotease in a protein removing process, wherein the temperature in the protein removing process is about 40° C. or below.

The present invention also relates to the use in laundry, dish wash or industrial cleaning process of a Thermolysin-Like Metalloprotease having at least one improved property compared to a serine protease or compared to Savinase and wherein the temperature in laundry, dish wash or cleaning process is performed at a temperature of about 40° C. or below.

In each of the above-identified methods and uses, the wash temperature is about 40° C. or below, such as about 39° C. or below, such as about 38° C. or below, such as about 37° C. or below, such as about 36° C. or below, such as about 35° C. or below, such as about 34° C. or below, such as about 33° C. or below, such as about 32° C. or below, such as about 31° C. or below, such as about 30° C. or below, such as about 29° C. or below, such as about 28° C. or below, such as about 27° C. or below, such as about 26° C. or below, such as about 25° C. or below, such as about 24° C. or below, such as about 23° C. or below, such as about 22° C. or below, such as about 21° C. or below, such as about 20° C. or below, such as about 19° C. or below, such as about 18° C. or below, such as about 17° C. or below, such as about 16° C. or below, such as about 15° C. or below, such as about 14° C. or below, such as about 13° C. or below, such as about 12° C. or below, such as about 11° C. or below, such as about 10° C. or below, such as about 9° C. or below, such as about 8° C. or below, such as about 7° C. or below, such as about 6° C. or below, such as about 5° C. or below, such as about 4° C. or below, such as about 3° C. or below, such as about 2° C. or below, such as about 1° C. or below.

In another preferred embodiment, the wash temperature is in the range of about 5-40° C., such as about 5-30° C., about 5-20° C., about 5-10° C., about 10-40° C., about 10-30° C., about 10-20° C., about 15-40° C., about 15-30° C., about 15-20° C., about 20-40° C., about 20-30° C., about 25-40° C., about 25-30° C., or about 30-40° C. In a particular preferred embodiment the wash temperature is about 30° C.

In particular embodiments, the low temperature washing method is conducted at a pH of from about 5.0 to about 11.5, or in alternative embodiments, even from about 6 to about 10.5, such as about 5 to about 11, about 5 to about 10, about 5 to about 9, about 5 to about 8, about 5 to about 7, about 5.5 to about 11, about 5.5 to about 10, about 5.5 to about 9, about 5.5 to about 8, about 5.5. to about 7, about 6 to about 11, about 6 to about 10, about 6 to about 9, about 6 to about 8, about 6 to about 7, about 6.5 to about 11, about 6.5 to about 10, about 6.5 to about 9, about 6.5 to about 8, about 6.5 to about 7, about 7 to about 11, about 7 to about 10, about 7 to about 9, or about 7 to about 8, preferably about 5.5 to about 9, and more preferably about 6 to about 8.

In particular embodiments, the low temperature washing method is conducted at a degree of hardness of from about 0° dH to about 30° dH, such as about 1° dH, about 2° dH, about 3° dH, about 4° dH, about 5° dH, about 6° dH, about 7° dH, about 8° dH, about 9° dH, about 10° dH, about 11° dH, about 12° dH, about 13° dH, about 14° dH, about 15° dH, about 16° dH, about 17° dH, about 18° dH, about 19° dH, about 20° dH, about 21° dH, about 22° dH, about 23° dH, about 24° dH, about 25° dH, about 26° dH, about 27° dH, about 28° dH, about 29° dH, about 30° dH. Under typical European wash conditions, the degree of hardness is about 15° dH, under typical US wash conditions about 6° dH, and under typical Asian wash conditions, about 3° dH.

Use in Removing Egg Stains

Another particular embodiment of the invention concerns removal of egg stains. These types of stain are often very difficult to remove completely. Egg stains are particularly problematic in hard surface cleaning such as dish wash where the stains often remain on the plates and cutlery after washing. The Thermolysin-Like Metalloproteases are particularly suitable for removing egg stains.

Thus, the invention further concerns methods for removing egg stains from textiles, fabrics and/or hard surfaces like dishes and cutlery in particular from fabrics and textiles. A preferred aspect of the invention concerns a method of removing egg stains from textiles and/or fabrics comprising contacting a surface in need of removal of an egg stain with a Thermolysin-Like Metalloprotease. In one embodiment, the invention comprises a method of removing egg stains from textiles and/or fabrics comprising contacting a surface in need of removal of an egg stain with a detergent composition comprising a Thermolysin-Like Metalloprotease. The invention also concerns a method of removing egg stains comprising adding a Thermolysin-Like Metalloprotease to a laundry and/or washing process wherein said textiles and/or fabric comprises various egg stains.

One embodiment of the present invention relates to a method for removal of egg stains from a hard surface or from laundry, the method comprising contacting the egg stain-containing hard surface or the egg stain-containing laundry with a cleaning or detergent composition, preferably a laundry or dish wash composition, containing a Thermolysin-Like Metalloprotease.

Another embodiment relates a method for removing egg stains from fabric or textile which comprises contacting the fabric or textile with a cleaning or detergent composition, preferably a laundry or dish wash composition, comprising a Themolysin-Like Metalloprotease.

A still further embodiment relates to a method for removing egg stains from fabric or textile which comprises contacting said a fabric or textile with a composition comprising a Thermolysin-Like Metalloprotease, wherein said composition further comprises at least one additional enzyme as set forth in the “other enzymes” section above, such as an enzyme selected from the group consisting of a carbohydrase, a peptidase, a protease, a lipase, a cellulase, a xylanase, a cutinase or a combination hereof.

In particular embodiments, the egg removing method is conducted at a pH of from about 5.0 to about 11.5, or in alternative embodiments, even from about 6 to about 10.5, such as about 5 to about 11, about 5 to about 10, about 5 to about 9, about 5 to about 8, about 5 to about 7, about 5.5 to about 11, about 5.5 to about 10, about 5.5 to about 9, about 5.5 to about 8, about 5.5. to about 7, about 6 to about 11, about 6 to about 10, about 6 to about 9, about 6 to to about 8, about 6 to about 7, about 6.5 to about 11, about 6.5 to about 10, about 6.5 to about 9, about 6.5 to about 8, about 6.5 to about 7, about 7 to about 11, about 7 to about 10, about 7 to about 9, or about 7 to about 8, preferably about 5.5 to about 9, and more preferably about 6 to about 8.

In particular embodiments, the egg removing method is conducted at a degree of hardness of from about 0° dH to about 30° dH, such as about 1° dH, about 2° dH, about 3° dH, about 4° dH, about 5° dH, about 6° dH, about 7° dH, about 8° dH, about 9° dH, about 10° dH, about 11° dH, about 12° dH, about 13° dH, about 14° dH, about 15° dH, about 16° dH, about 17° dH, about 18° dH, about 19° dH, about 20° dH, about 21° dH, about 22° dH, about 23° dH, about 24° dH, about 25° dH, about 26° dH, about 27° dH, about 28° dH, about 29° dH, about 30° dH. Under typical European wash conditions, the degree of hardness is about 15° dH, under typical US wash conditions about 6° dH, and under typical Asian wash conditions, about 3° dH.

All documents cited herein are incorporated by reference in the entirety.

The present invention is further described by the following examples that should not be construed as limiting the scope of the invention.

### EXAMPLES

### Materials and Methods

### Purification Activity Assays:

### Protazyme AK Purification Activity Assay:

Substrate: Protazyme AK tablet (AZCL-casein, Megazyme T-PRAK 1000).
Temperature: 37° C.
Assay buffer: 50 mM HEPES/NaOH, pH 7.0.

A Protazyme AK tablet is suspended in 2.0 ml 0.01% Triton X-100 by gentle stirring. 500 μl of this suspension and 500 μl assay buffer are dispensed in an Eppendorf tube and placed on ice. 20 μl protease sample (diluted in 0.01% Triton X-100) is added to the ice cold tube. The assay is initiated by transferring the Eppendorf tube to an Eppendorf thermomixer, which is set to the assay temperature. The tube is incubated for 15 minutes on the Eppendorf thermomixer at its highest shaking rate (1400 rpm). The incubation is stopped by transferring the tube back to the ice bath. Then the tube is centrifuged in an ice cold centrifuge for a few minutes and 200 μl supernatant is transferred to a microtiter plate. OD₆₅₀ was read as a measure of protease activity. A buffer blind is included in the assay (instead of enzyme).

### Characterization Activity Assays:

### Protazyme AK Characterization Assay:

Substrate: Protazyme AK tablet (AZCL-casein, Megazyme T-PRAK 1000).
Temperature: Controlled (assay temperature).
Assay buffers: 100 mM succinic acid, 100 mM HEPES, 100 mM CHES, 100 mM CABS,
   1 mM CaCl₂, 150 mM KCl, 0.01% Triton X-100 adjusted to pH-values 3.0, 4.0, 5.0, 6.0, 7.0, 8.0, 9.0, 10.0 and 11.0 with HCl or NaOH.

A Protazyme AK tablet is suspended in 2.0 ml 0.01% Triton X-100 by gentle stirring. 500 μl of this suspension and 500 μl assay buffer are dispensed in an Eppendorf tube and placed on ice. 20 μl protease sample (diluted in 0.01% Triton X-100) is added to the ice cold tube. The assay is initiated by transferring the Eppendorf tube to an Eppendorf thermomixer, which is set to the assay temperature. The tube is incubated for 15 minutes on the Eppendorf thermomixer at its highest shaking rate (1400 rpm). The incubation is stopped by transferring the tube back to the ice bath. Then the tube is centrifuged in an ice cold centrifuge for a few minutes and 200 μl supernatant is transferred to a microtiter plate. OD₆₅₀ is read as a measure of protease activity. A buffer blind is included in the assay (instead of enzyme).

### Protazyme OL Characterization Assay:

Substrate: Protazyme OL tablet (AZCL-collagen, Megazyme T-PRO11000).
Temperature: Controlled (assay temperature).
Assay buffers: 100 mM succinic acid, 100 mM HEPES, 100 mM CHES, 100 mM CABS, 1 mM CaCl₂, 150 mM KCl, 0.01% Triton X-100 adjusted to pH-values 2.0, 3.0, 4.0, 5.0, 6.0, 7.0, 8.0, 9.0, 10.0 and 11.0 with HCl or NaOH.

A Protazyme OL tablet is suspended in 2.0 ml 0.01% Triton X-100 by gentle stirring. 500 μl of this suspension and 500 μl assay buffer are dispensed in an Eppendorf tube and placed on ice. 20 μl protease sample (diluted in 0.01% Triton X-100) is added to the ice cold tube. The assay is initiated by transferring the Eppendorf tube to an Eppendorf thermomixer, which is set to the assay temperature. The tube is incubated for 15 minutes on the Eppendorf thermomixer at its highest shaking rate (1400 rpm). The incubation is stopped by transferring the tube back to the ice bath. Then the tube is centrifuged in an ice cold centrifuge for a few minutes and 200 μl supernatant is transferred to a microtiter plate. OD₆₅₀ is read as a measure of protease activity. A buffer blind is included in the assay (instead of enzyme).

### Automatic Mechanical Stress Assay (AMSA) for Laundry

In order to assess the wash performance in laundry washing experiments are performed, using the Automatic Mechanical Stress Assay (AMSA). With the AMSA, the wash performance of a large quantity of small volume enzyme-detergent solutions can be examined. The AMSA plate has a number of slots for test solutions and a lid firmly squeezing the laundry sample, the textile to be washed against all the slot openings. During the washing time, the plate, test solutions, textile and lid are vigorously shaken to bring the test solution in contact with the textile and apply mechanical stress in a regular, periodic oscillating manner. For further description see WO 2002/42740 especially the paragraph “Special method embodiments” at page 23-24.

The laundry experiments are conducted under the experimental conditions specified below:

| | |
|---|---|
| Detergent dosage | 5 g/L (Laundry Liquid Model Detergent) |
| | 2.5 g/L (Laundry Powder Model Detergent) |
| Enzyme dosage | 30 nM |
| Test solution volume | 160 microliters (140 microliters detergent and 20 |
| | microliters enzyme per slot) |
| pH | Adjusted to pH 7 or pH 6 (Laundry Liquid Model |
| | Detergent) |
| | As is, pH 8.2 (Laundry Powder Model Detergent) |
| Wash time | 20 minutes |
| Temperature | 60° C., 40° C., 30° C., 20° C. and 15° C. |
| Water hardness | 15°dH |

Model detergents and test materials are as follows:

| | |
|---|---|
| Laundry Liquid | Sodium alkylethoxy sulphate (C-9-15, 2EO) 6.0% |
| Model Detergent | Sodium dodecyl benzene sulphonate 3.0% |
| | Sodium toluene sulphonate 3.0% |
| | Olic acid 2.0% |
| | Primary alcohol ethoxylate (C12-15, 7EO) 3.0% |
| | Primary alcohol ethoxylate (C12-15, 3EO) 2.5% |
| | Ethanol 0.5% |
| | Monopropylene glycol 2.0% |
| | Tri-sodium citrate 2H2O 4.0% |
| | Triethanolamine 0.4% |
| | De-ionized water ad 100% |
| | pH adjusted to 8.5 with NaOH |
| Laundry Powder | Sodium citrate dihydrate 32.3% |
| Model Detergent | Sodium-LAS 24.2% |
| | Sodium lauryl sulfate 32.2% |
| | Neodol 25-7 (alcohol ethoxylate) 6.4% |
| | Sodium sulfate 4.9% |
| Test Material | EMPA112 (Cocoa on cotton) |
| | PC-05 (Blood/milk/ink on cotton/polyester) |
| | WFK10PPM (Vegetable oil/milk/pigment on cotton) |
| | C-10 (Oil/milk/pigment on cotton) |
| | CS-36 (Egg yolk/pigment on cotton) |
| | CS-37 (Full egg/pigment on cotton) |
| | CS-39 (Aged full egg/pigment on cotton) |

All test materials are obtained from EMPA Testmaterials AG Mövenstrasse 12, CH-9015 St. Gallen, Switzerland, from Center For Testmaterials BV, P.O. Box 120, 3133 KT Vlaardingen, the Netherlands, and WFK Testgewebe GmbH, Christenfeld 10, D-41379 Brüggen, Germany.

Water hardness is adjusted to 15° dH by addition of CaCl₂, MgCl₂, and NaHCO₃ (Ca²⁺:Mg²⁺:NaHCO₃=4:1:7.5) to the test system. After washing the textiles were flushed in tap water and dried.

The wash performance is measured as the brightness of the colour of the textile washed. Brightness can also be expressed as the intensity of the light reflected from the sample when illuminated with white light. When the sample is stained the intensity of the reflected light is lower than that of a clean sample. Expressed another way, a cleaner sample will reflect more light and will have a higher intensity. Therefore the intensity of the reflected light can be used to measure wash performance.

Color measurements are made with a professional flatbed scanner (Kodak iQsmart, Kodak, Midtager 29, DK-2605 Brondby, Denmark), which is used to capture an image of the washed textile.

To extract a value for the light intensity from the scanned images, 24-bit pixel values from the image are converted into values for red, green and blue (RGB). The intensity value (Int) is calculated by adding the RGB values together as vectors and then taking the length of the resulting vector:

Int=\sqrt{r²+g²+b²}.

### Example 1

### Purification of Gs1 from Geobacillus stearothermophilus and Bca1 from Bacillus caldolyticus

The Gs1 and Bca1 proteases were both expressed in B. subtilis.

The culture broth was centrifuged (20000×g, 20 min) and the supernatant was carefully decanted from the precipitate. The supernatant was filtered through a Nalgene 0.2 μm filtration unit in order to remove the rest of the Bacillus host cells. The 0.2 μm filtrate was transferred to 50 mM H₃BO₃, 5 mM Dimethylglutaric acid, 1 mM CaCl₂, pH 7 on a G25 sephadex column (from GE Healthcare). The G25 sephadex transferred enzyme was applied to a Bacitracin agarose column (from Upfront chromatography) equilibrated in 50 mM H₃BO₃, 5 mM Dimethylglutaric acid, 1 mM CaCl₂, pH 7. After washing the column extensively with the equilibration buffer, the thermolysin protease was eluted with 100 mM H₃BO₃, 10 mM MES, 2 mM CaCl₂, 1M NaCl, pH 6 with 25% (v/v) 2-propanol. Fractions from the column were analysed for protease activity (Protazyme AK purification activity assay at pH 7) and active fractions were further analysed by SDS-PAGE. Fractions, where only one band was seen on the coomassie stained SDS-PAGE gel, were pooled and transferred to 50 mM H₃BO₃, 5 mM Dimethylglutaric acid, 1 mM CaCl₂, pH 7 on a G25 sephadex column as the purified preparation and was used for further characterization.

### Example 2

### Purification of Bm1 from Bacillus meqaterium and Bce1 and Bce2 from Bacillus cereus

The Bm1, Bce1 and Bce2 proteases were expressed in B. subtilis.

The culture broth was centrifuged (20000×g, 20 min) and the supernatant was carefully decanted from the precipitate. The supernatant was filtered through a Nalgene 0.2 μm filtration unit in order to remove the rest of the Bacillus host cells. The 0.2 μm filtrate was transferred to 50 mM H₃BO₃, 5 mM Dimethylglutaric acid, 1 mM CaCl₂, pH 7 on a G25 sephadex column (from GE Healthcare). The G25 sephadex transferred enzyme was applied to a Bacitracin agarose column (from Upfront chromatography) equilibrated in 50 mM H₃BO₃, 5 mM Dimethylglutaric acid, 1 mM CaCl₂, pH 7. After washing the column extensively with the equilibration buffer, the M4 protease was eluted with 100 mM H₃BO₃, 10 mM MES, 2 mM CaCl₂, 1M NaCl, pH 6 with 25% (v/v) 2-propanol. Fractions from the column were analysed for protease activity (Protazyme AK purification activity assay at pH 7) and active fractions were further analysed by SDS-PAGE. Fractions, where only one band was seen on the coomassie stained SDS-PAGE gel, were pooled and transferred to 50 mM H₃BO₃, 5 mM Dimethylglutaric acid, 1 mM CaCl₂, pH 7 on a G25 sephadex column as the purified preparation and was used for further characterization.

### Example 3

### Characterization of Bm1, Bce1 and Bce2 Proteases: pH-Activity and pH-Stability

The Protazyme OL characterization assay was used for obtaining the pH-activity profile at 37° C., and the pH-stability profile (residual activity after 2 hours at indicated pH-values) at pH optimum, as described in the Materials and Methods section. For the pH-stability profile the protease was diluted 8 times in the different characterization assay buffers to reach the pH-values of these buffers and incubated for 2 hours at 37° C. After incubation, the pH of the protease incubations was transferred to the pH optimum of the protease, before assay for residual activity, by dilution in the pH optimum assay buffer. The results are shown in the Tables below. For Table 3, the activities are relative to the optimal pH for the enzyme. For Table 4, the activities are residual activities relative to a sample, which was kept at stable conditions (5° C., pH optimum).

Characterization of Gs1 and Bca1 Proteases: pH-Activity and pH-Stability

The Protazyme AK characterization assay was used for obtaining the pH-activity profile at 37° C., and the pH-stability profile (residual activity after 2 hours at indicated pH-values) at pH optimum, as described in the Materials and Methods section. For the pH-stability profile the protease was diluted at least 8 times in the different characterization assay buffers to reach the pH-values of these buffers and incubated for 2 hours at 37° C. After incubation, the pH of the protease incubations was transferred to the pH optimum of the protease, before assay for residual activity, by dilution in the pH optimum assay buffer. The results are shown in the Tables below. For Table 3, the activities are relative to the optimal pH for the enzyme. For Table 4, the activities are residual activities relative to a sample, which was kept at stable conditions (5° C., pH optimum).

TABLE 3
pH-activity profile at 37° C.

| pH | Gs1 | Bca1 | Bm1 | Bce1 | Bce2 |
|---|---|---|---|---|---|
| 3 | 0.00 | 0.02 | 0.00 | 0.00 | 0.00 |
| 4 | 0.00 | 0.00 | 0.00 | 0.00 | 0.00 |
| 5 | 0.00 | 0.00 | 0.00 | 0.00 | 0.00 |
| 6 | 0.04 | 0.06 | 0.03 | 0.07 | 0.06 |
| 7 | 0.21 | 0.41 | 0.21 | 0.54 | 0.57 |
| 8 | 1.00 | 1.00 | 1.00 | 1.00 | 1.00 |
| 9 | 0.83 | 0.79 | 0.34 | 0.22 | 0.30 |
| 10 | 0.20 | 0.23 | 0.03 | 0.02 | 0.02 |
| 11 | 0.05 | 0.03 | 0.01 | 0.00 | 0.01 |

TABLE 4
pH-stability profile (residual activity after 2 hours at 37° C.)

| pH | Gs1 | Bca1 | Bm1 | Bce1 | Bce2 |
|---|---|---|---|---|---|
| 3 | 0.00 | 0.00 | 0.01 | 0.00 | 0.04 |
| 4 | 0.02 | 0.00 | 0.01 | 0.00 | 0.01 |
| 5 | 0.98 | 0.89 | 0.15 | 0.79 | 0.71 |
| 6 | 1.09 | 0.95 | 0.95 | 0.94 | 0.88 |
| 7 | 0.96 | 0.99 | 1.02 | 0.94 | 0.84 |
| 8 | 1.13 | 0.96 | 1.03 | 1.00 | 0.88 |
| 9 | 1.13 | 0.90 | 0.85 | 1.02 | 0.98 |
| 10 | 1.13 | 0.99 | 0.42 | 0.95 | 0.72 |
| 11 | 0.98 | 0.96 | 0.02 | 0.77 | 0.21 |
| After 2 hours | 1.00 | 1.00 | 1.00 | 1.00 | 1.00 |
| at 5° C. | (at pH 8) | (at pH 8) | (at pH 8) | (at pH 7) | (at pH 7) |

### Other Characteristics

The M4 proteases are inhibited by 1,10-phenanthroline and EDTA.

The sequence listing provides the found N-terminal sequences and the mature sequences deduced from the N-terminal sequences and intact mass measurements. In addition to N-terminal sequence and intact mass analysis, the M4 protease Bca1 from Bacillus caldolyticus was checked by a peptide map covering 72% of the mature sequence. This analysis showed that the purified M4 protease has a M44T substitution in the mature sequence.

The M4 protease Gs1 from Geobacillus stearothermophilus was also checked by a peptide map covering 83% of the mature sequence. This analysis gave a 14.56 Da molecular weight difference which couldn't be resolved. This could be due to a methylation or an amino acid substitution in the remaining 17% of the sequence.

### Example 4

### Evaluation of Detergency

### Exemplary Thermolysin-Like Metalloproteases at Various Temperatures

Detergency of Bca1, Gs1, Bce1, Bm1 and Bce2 proteases was investigated in AMSA as described above on different stains and temperatures. The liquid detergent was in all cases adjusted to pH 7, except for the experiments with PC-05 (20° C.) in Table 6. The Tables show the determined intensity values relative to detergent without protease, using both Laundry Liquid Model Detergent (Tables 5-6) and Laundry Powder Model Detergent (Tables 7-8) systems.

TABLE 5
Determined intensity values of
Exemplary Thermolysin-Like Metalloproteases to detergent
without protease in Laundry Liquid Model Detergent

| Thermolysin-Like | EMPA112 | PC-05 | C-10 |
|---|---|---|---|
| Metalloprotease | (60° C.) | (30° C.) | (40° C.) |
| Bca1 | 15 | 50 | 19 |
| Gs1 | 12 | 27 | 14 |

TABLE 6
Determined intensity values of
Exemplary Thermolysin-Like Metalloproteases to detergent
without protease in Laundry Liquid Model Detergent

| Thermolysin-Like | EMPA112 | PC-05 | C-10 |
|---|---|---|---|
| Metalloprotease | (60° C.) | (20° C.) | (40° C.) |
| Bce1 | 14 | 23 | 18 |
| Bm1 | 16 | 25 | 22 |
| Bce2 | 16 | 17 | 19 |

TABLE 7
Determined intensity values of
Exemplary Thermolysin-Like Metalloproteases to detergent
without protease in Laundry Powder Model Detergent

| Thermolysin-Like | EMPA112 | PC-05 | WFK10PPM |
|---|---|---|---|
| Metalloprotease | (20° C.) | (30° C.) | (40° C.) |
| Bca1 | 10 | 60 | 13 |
| Gs1 | 10 | 44 | 11 |

TABLE 8
Determined intensity values of
Exemplary Thermolysin-Like Metalloproteases to detergent
without protease in Laundry Powder Model Detergent

| Thermolysin-Like | EMPA112 | PC-05 | C-10 |
|---|---|---|---|
| Metalloprotease | (20° C.) | (15° C.) | (60° C.) |
| Bce1 | 11 | 45 | 14 |
| Bm1 | 10 | 40 | 8 |
| Bce2 | 9 | 40 | 15 |

From Tables 5-8 above it is clear that the Thermolysin-Like Metalloproteases significantly increase the detergency compared to when no protease is present.

### Example 5

### Evaluation of Low Temperature Performance of Exemplary Thermolysin-Like Metalloproteases

The low temperature performance of the Thermolysin-Like Metalloproteases Bca1, Bce1, Bce2 and Bm1 compared to Savinase was investigated in AMSA as described above. The liquid detergent was adjusted to pH 7 in case of EMPA112 and C-10, and to pH6 in case of PC-05. The Tables show the determined wash performance of detergent with Thermolysin-Like Metalloprotease relative to detergent with Savinase, in both Laundry Liquid Model Detergent (Table 9) and Laundry Powder Model Detergent (Table 10).

TABLE 9
Comparison of Exemplary Thermolysin-Like Metalloproteases
to Savinase in Laundry Liquid Model Detergent

| | C-10 | | | EMPA112 | | | PC-05 | | |
|---|---|---|---|---|---|---|---|---|---|
| | 15° C. | 40° C. | 60° C. | 20° C. | 40° C. | 60° C. | 20° C. | 40° C. | 60° C. |
| Savinase | 100% | 100% | 100% | 100% | 100% | 100% | 100% | 100% | 100% |
| Bca1 | 119% | 107% | 94% | 170% | 110% | 119% | 101% | 106% | 101% |
| Bce1 | | | | | | | 144% | 100% | 75% |
| Bm1 | 190% | 122% | 99% | | | | 155% | 127% | 110% |

TABLE 10
Comparison of Exemplary Thermolysin-Like Metalloproteases
to Savinase in Laundry Powder Model Detergent

| | WFK10PPM | | | EMPA112 | | | PC-05 | | |
|---|---|---|---|---|---|---|---|---|---|
| | 15° C. | 40° C. | 60° C. | 20° C. | 40° C. | 60° C. | 20° C. | 40° C. | 60° C. |
| Savinase | 100% | 100% | 100% | 100% | 100% | 100% | 100% | 100% | 100% |
| Bca1 | 112% | 107% | 103% | 143% | 111% | | 132% | 117% | 116% |
| Bce2 | | | | 115% | 114% | 109% | 126% | 118% | 105% |
| Bm1 | 91% | 101% | 59% | 129% | 133% | 17% | 124% | 122% | 48% |
| Bce1 | 97% | 105% | 100% | 146% | 141% | 113% | 140% | 113% | 96% |

It is clear from Tables 9-10 that the Thermolysin-Like Metalloproteases Bca1, Bce1, Bm 1 and Bce 2 overall have an increased wash performance when compared to Savinase at temperature at or below 40° C. At 60° C. on the other hand, the tested Thermolysin-Like Metalloproteases just match or perform worse than Savinase. This clearly shows that these Thermolysin-Like Metalloproteases perform especially well at low temperatures.

### Example 7

### Evaluation of Performance on Egg of Exemplary Thermolysin-Like Metalloproteases

The performance of the Bca1, Gs1, Bce1, Bm1 and Bce2 proteases compared to Savinase on different egg stains was investigated in AMSA as described above. The liquid detergent was adjusted to pH 7 (Table 11) and pH 6 (Table 12) respectively. The Tables show the determined wash performance of detergent with Thermolysin-Like Metalloprotease relative to detergent with Savinase at 30° C. (Table 11) and 20° C. (Table 12).

TABLE 11
Comparison of Exemplary Thermolysin-Like Metalloproteases
to Savinase in Model Detergent (30° C.)

| | CS-36 | CS-37 | | CS-39 | |
|---|---|---|---|---|---|
| | Liquid | Liquid | Powder | Liquid | Powder |
| Savinase | 100% | 100% | 100% | 100% | 100% |
| Bca1 | 228% | 386% | 168% | 1940% | 764% |
| Gs1 | 167% | 299% | 100% | 918% | 446% |

TABLE 12
Comparison of Exemplary Thermolysin-Like Metalloproteases
to Savinase in Model Detergent (20° C.)

| | CS-37 | | CS-39 | |
|---|---|---|---|---|
| | Liquid | Powder | Liquid | Powder |
| Savinase | 100% | 100% | 100% | 100% |
| Bce1 | 1795% | 355% | 308% | 854% |
| Bm1 | 1942% | 310% | 281% | 838% |
| Bce2 | 1700% | 307% | 276% | 784% |

It is clear from Tables 11-12 that the Thermolysin-Like Metalloproteases have increased wash performance on various egg stains compared to Savinase.

The present invention can also be described by the following particular embodiments.

Embodiment 1. The use of a Thermolysin-Like Metalloprotease in a cleaning process.

Embodiment 2. The use according to Embodiment 1, wherein the Thermolysin-Like Metalloprotease comprises an active cleft motif: TG[TS][QS]DNGGVH[TI].

Embodiment 3. The use according to Embodiment 1 or 2, wherein the Thermolysin-Like Metalloprotease comprises an active cleft motif: DPDHYSKRYTG[TS][QS]DNGGVH[TI]NSGI.

Embodiment 4. The use according to Embodiment 1, wherein the Thermolysin-Like Metalloprotease comprises an active cleft motif: NT[TS][QS]DNGGVH[TI]NSGI.

Embodiment 5. The use according to any of the preceding Embodiments, wherein the Thermolysin-Like Metallo-protease is selected from the group consisting of:

a) an M4 metalloprotease of the MEROPS subclass M04.001;
b) an M4 metalloprotease of the MEROPS subclass M04.018; and
c) an M4 metalloprotease of the MEROPS subclass M04.021.

Embodiment 6. The use according to any of the preceding Embodiments, wherein the protease comprises an amino acid sequence having at least 70% sequence identity to the mature polypeptide of SEQ ID NO: 1, 2, 3, 4, or 5.

Embodiment 7. The use according to any of the preceding Embodiments, wherein the cleaning process is a laundry process.

Embodiment 8. The use according to any of Embodiments 1-6, wherein the cleaning process is a dish wash process.

Embodiment 9. The use according to any of the preceding Embodiments, wherein the polypeptide comprises an amino acid sequence having at least 80%, preferably at least 85%, preferably at least 90%, preferably at least 95% sequence identity to the mature polypeptide of SEQ ID NO: 1, 2, 3, 4, or 5.

Embodiment 10. The use according to any of the preceding Embodiments, wherein the cleaning process is performed at a temperature of 40° C. or below, preferably 35° C. or below, preferably 30° C. or below, preferably 25° C. or below, preferably 20° C. or below.

Embodiment 11. The use according to any of the preceding Embodiments, wherein the cleaning process is per-formed at a pH between 5.5 and 9, preferably 6 and 8.

Embodiment 12. A method of cleaning, said method comprising the steps of: contacting an surface in need of cleaning with a Thermolysin-Like Metalloprotease.

Embodiment 13. The method of Embodiment 12, wherein the Thermolysin-Like Metalloprotease comprises an active cleft motif: TG[TS][QS]DNGGVH[TI].

Embodiment 14. The method of Embodiment 12 or 13, wherein the Thermolysin-Like Metalloprotease comprises an active cleft motif: DPDHYSKRYTG[TS][QS]DNGGVH[TI]NSGI.

Embodiment 15. The method of Embodiment 12, wherein the Thermolysin-Like Metalloprotease comprises an active cleft motif: NT[TS][QS]DNGGVH[TI]NSGI.

Embodiment 16. The method of any of Embodiments 12-15, wherein the Thermolysin-Like Metalloprotease is selected from the group consisting of:

a) an M4 metalloprotease of the MEROPS subclass M04.001;
b) an M4 metalloprotease of the MEROPS subclass M04.018; and
c) an M4 metalloprotease of the MEROPS subclass M04.021.

Embodiment 17. The method of any of Embodiments 12-16, wherein the protease comprises an amino acid sequence having at least 70% sequence identity to the mature polypeptide of SEQ ID NO: 1, 2, 3, 4, or 5.

Embodiment 18. The method of any of Embodiments 12-17, wherein the cleaning process is a laundry process.

Embodiment 19. The method of any of Embodiments 12-17, wherein the cleaning process is a dish wash process.

Embodiment 20. The method of any of Embodiments 12-19, wherein the polypeptide comprises an amino acid sequence having at least 80%, preferably at least 85%, preferably at least 90%, preferably at least 95% sequence identity to the mature polypeptide of SEQ ID NO: 1, 2, 3, 4, or 5.

Embodiment 21. The method of any of Embodiments 12-20, wherein the cleaning process is performed at a temperature of 40° C. or below, preferably 35° C. or below, preferably 30° C. or below, preferably 25° C. or below, preferably 20° C. or below.

Embodiment 22. The method of any of Embodiments 12-21, wherein the cleaning process is performed at a pH between 5.5 and 9, preferably 6 and 8.

Embodiment 23. A composition comprising a Thermolysin-Like Metalloprotease and an excipient surfactant.

Embodiment 24. The composition of Embodiment 23, wherein the Thermolysin-Like Metalloprotease comprises an active cleft motif: TG[TS][QS]DNGGVH[TI].

Embodiment 25. The composition of Embodiment 23 or 24, wherein the Thermolysin-Like Metalloprotease comprises an active cleft motif: DPDHYSKRYTG[TS][QS]DNGGVH[TI]NSGI.

Embodiment 26. The composition of Embodiment 23, wherein the Thermolysin-Like Metalloprotease comprises an active cleft motif: NT[TS][QS]DNGGVH[TI]NSGI.

Embodiment 27. The composition of any of Embodiments 23-26, wherein the Thermolysin-Like Metalloprotease is selected from the group consisting of:

a) an M4 metalloprotease of the MEROPS subclass M04.001;
b) an M4 metalloprotease of the MEROPS subclass M04.018; and
c) an M4 metalloprotease of the MEROPS subclass M04.021.

Embodiment 28. The composition of any of Embodiments 23-26, wherein the protease comprises an amino acid sequence having at least 70% sequence identity to the mature polypeptide of SEQ ID NO: 1, 2, 3, 4, or 5.

Embodiment 29. The composition of any of Embodiments 23-28, further comprising at least one additional enzyme selected from the group consisting of carbohydrases, peptidases, proteases, lipases, cellulase, xylanases or cutinases or a combination thereof.

Embodiment 30. The composition according to any of Embodiments 23-29, which is a cleaning composition.

Embodiment 31. The composition according to any of Embodiments 23-29, which is a detergent composition.

Embodiment 32. The composition according to any of Embodiments 23-31, wherein the polypeptide comprises an amino acid sequence having at least 80%, preferably at least 85%, preferably at least 90%, preferably at least 95% identity to the mature polypeptide of SEQ ID NO: 1, 2, 3, 4, or 5.

Embodiment 33. The composition according to any of Embodiments 23-32, for use in a low temperature cleaning process.

Embodiment 34. The composition according to any of Embodiments 23-32, for use in a process for removing egg stains.

Embodiment 35. A method for removing a stain from a surface which comprises contacting the surface with a composition according to any of Embodiments 23-32.

Embodiment 36. The method according to Embodiment 35, wherein the stain is an egg stain.

Embodiment 37. The method according to any of Embodiments 35-36, which is a dish wash process.

Embodiment 38. The method according to any of Embodiments 35-36, wherein the surface is a fabric or textile.

Embodiment 39. The method according to any of Embodiments 35-38, wherein the stain removing process is performed at a pH between 5.5 and 9, preferably 6 and 8.

1-17. (canceled)

18. A method of cleaning, said method comprising the steps of: contacting a surface in need of cleaning with a Thermolysin-Like Metalloprotease.

19. The method of claim 18, wherein the Thermolysin-Like Metalloprotease comprises an active cleft motif: TG[TS][QS]DNGGVH[TI].

20. The method of claim 18, wherein the Thermolysin-Like Metalloprotease comprises an active cleft motif: DPDHYSKRYTG[TS][QS]DNGGVH[TI]NSGI.

21. The method of claim 18, wherein the Thermolysin-Like Metalloprotease comprises an active cleft motif: NT[TS][QS]DNGGVH[TI]NSGI.

22. The method of claim 18, wherein the Thermolysin-Like Metalloprotease is selected from the group consisting of:
a) an M4 metalloprotease of the MEROPS subclass M04.001;
b) an M4 metalloprotease of the MEROPS subclass M04.018;
c) an M4 metalloprotease of the MEROPS subclass M04.021.

23. The method of claim 18, wherein the protease comprises an amino acid sequence having at least 70% sequence identity to the mature polypeptide of SEQ ID NOs: 1, 2, 3, 4, or 5.

24. The method of claim 18, wherein the protease comprises an amino acid sequence having at least 90% sequence identity to the mature polypeptide of SEQ ID NO: 1, 2, 3, 4, or 5.

25. The method of claim 18, wherein the cleaning process is a laundry process.

26. The method of claim 18, wherein the cleaning process is a dish wash process.

27. The method of claim 18, wherein the cleaning process is performed at a temperature of 40° C. or below.

28. The method of claim 18, wherein the cleaning process is performed at a pH between 5.5 and 9.

29. A composition comprising a Thermolysin-Like Metalloprotease and a surfactant.

30. The composition of claim 29, wherein the Thermolysin-Like Metalloprotease comprises an active cleft motif: TG[TS][QS]DNGGVH[TI].

31. The composition of claim 29, wherein the Thermolysin-Like Metalloprotease comprises an active cleft motif: DPDHYSKRYTG[TS][QS]DNGGVH[TI]NSGI.

32. The composition of claim 29, wherein the Thermolysin-Like Metalloprotease comprises an active cleft motif: NT[TS][QS]DNGGVH[TI]NSGI.

33. The composition of claim 29, wherein the Thermolysin-Like Metalloprotease is selected from the group consisting of:
d) an M4 metalloprotease of the MEROPS subclass M04.001;
e) an M4 metalloprotease of the MEROPS subclass M04.018;
f) an M4 metalloprotease of the MEROPS subclass M04.021.

34. The composition of claim 29, wherein the protease comprises an amino acid sequence having at least 70% sequence identity to the mature polypeptide of SEQ ID NOs: 1, 2, 3, 4, or 5.

35. The composition of claim 29, wherein the protease comprises an amino acid sequence having at least 90% sequence identity to the mature polypeptide of SEQ ID NO: 1, 2, 3, 4, or 5.
